(19) United States
(12) Patent Application Publication
(10) Pub. No.: US 2026/0309403 A1
(43) Pub. Date: Oct. 8, 2026

(54) REFRIGERATOR

(71) Applicant: LG ELECTRONICS INC., Seoul (KR)

(72) Inventors: Chungseob LEE, Seoul (KR); Namgyo LEE, Seoul (KR); Wonho PARK, Seoul (KR)

(73) Assignee: LG ELECTRONICS INC., Seoul (KR)

(21) Appl. No.: 19/484,731

(22) PCT Filed: May 16, 2024
(86) PCT No.: PCT/KR2024/006668

§ 371 Date: Nov. 14, 2025

(30) Foreign Application Priority Data
May 16, 2023 (KR) 10-2023-0063151
Jan. 24, 2024 (KR) 10-2024-0011187

(51) Int. Cl. F25D 23/02; E05B 5/00; E05F 11/54

(52) U.S. Cl. CPC F25D 23/028; E05B 5/00; E05F 11/54; F25D 23/021; E05Y 2900/31

(57) ABSTRACT

A refrigerator of the present disclosure may comprise: a cabinet for providing a storage space; a door for opening and closing the storage space; a handle receiving external force so as to rotate around a first axis; and a pusher, which receives the external force so as to move the door far away from the cabinet when the door is opened.

### TECHNICAL FIELD

The present disclosure relates to a

### BACKGROUND ART

A refrigerator has a storage space that can be enclosed by a door. The storage space can store food at low temperatures. Refrigerator can utilize a cold air generated through heat exchange with a refrigerant circulating in a refrigeration cycle. Recently, refrigerators have become increasingly larger and more multifunctional in line with changes in dietary habits and the trend towards higher-end products. Recently, a variety of refrigerators have been launched to enhance user convenience and enable efficient use of internal space.

The storage space of refrigerator can be opened and closed by a door. In addition, refrigerators can be categorized into various types depending on the layout of the storage space and the structure of a door that opens and closes the storage space. For example, the door of refrigerator can be opened and closed by rotating it or by sliding it in and out.

The door can be opened and closed by a user. If a door is large and heavy, has a large pressure difference between the inside and outside of the refrigerator, and/or has a strong magnetic force on a door gasket, it is difficult to handle the door. For example, the door may require greater force to open. This may cause inconvenience to a user. A door that can solve this problem has been introduced. For example, there is Korean Patent No. 10-1528729B1. This technology can achieve some improvements in user convenience, but it also has other technical problems.

### DISCLOSURE

### Technical Problem

The present invention discloses a door with a reduced volume of a user operating part.

The present invention discloses a door with high insulation efficiency.

The present invention discloses a door capable of preventing frost formation.

The present invention discloses a door with improved stability of mechanical operation.

The present invention discloses a door with improved reliability for door opening.

### Technical Solution

The refrigerator of the present disclosure may include a cabinet providing a storage space; a door for opening and closing the storage space; and a handle that rotates around a first axis when an external force is applied. The refrigerator may include a pusher that moves the door away from the cabinet when the door is opened by receiving the external force.

Selectively, the refrigerator may include a second pressing part that is provided on the handle and configured to transmit the external force to the pusher. The second pressing part may be positioned in a first direction with respect to the first axis, when a direction facing a point where the external force is applied with respect to the first axis is defined as the first direction. The first direction may be an upward direction. The upward direction may be a direction opposite to gravity. The refrigerator may include a contact member with which the external force comes into contact when the door is opened. The refrigerator may include a handle that is interposed between the contact member and the pusher and rotates. The refrigerator may include a first pressing part that is provided on the handle and configured to receive the external force, and formed in the first direction with respect to the first axis. The refrigerator may include a second pressing part that is provided on the handle and configured to transmit the external force to the pusher, and formed in the first direction with respect to the first axis. A first portion that is provided on the handle and configured to receive the external force, and a second portion that is provided on the handle and configured to transmit the external force to the pusher may be positioned in the same direction with respect to the first axis.

Selectively, the refrigerator may include a link that is interposed between the handle and the pusher and rotates. The refrigerator may include a second axis supporting the rotation of the link. The second axis may be positioned in a first direction of the first axis. A contact portion between the link and the handle may be provided in a second direction with respect to the second axis. The first direction and the second direction may be opposite directions. The second axis may be closer to the point of application of the external force than the first axis.

Selectively, the refrigerator may include a first virtual axis in a front-rear direction (Y) with respect to the first axis and a second virtual axis in an up-down direction (Z) with respect to the first axis, in which when the first virtual axis is defined as a X-axis and the second virtual axis is defined as a Y-axis to provide a quadrant, with respect to the quadrant, the second axis is closer to the cabinet (−Y) than the first axis, is far from the cabinet (+Y), or at least partially overlaps vertically. The second axis, with respect to the quadrant, is closer to a front of the door (−Y) than the first axis, is far from the front of the door (+Y), or at least partially overlaps vertically.

Selectively, the extension direction of the first axis may intersect with the extension direction of the second axis. The extension direction of the first axis may be parallel to the extension direction of the second axis.

Selectively, the refrigerator may include a case having an upper surface that is open to accommodate at least a portion of the handle. The refrigerator may include a cover that is provided on both sides of the case, and supporting the first axis. The cover may guide the pusher. The refrigerator may include a support plate that accommodates the handle. The support plate may include an inner support plate that supports the first axis; and an outer support plate fastened to the inner support plate. The refrigerator may include an open gap that is provided on a side surface of the case and through which the first axis passes; and a shafting that supports the second axis in the first direction of the open gap. The refrigerator may include a cover that is provided on at least one side of the inner support plate, and supports at least one of the first axis and/or the second axis. The cover may include a first surface that provides a first shafting that supports the first axis; and a second surface that provides a second shafting that supports the second axis, and is different from the first surface.

Selectively, the refrigerator may satisfy at least one of a condition wherein the handle pushes the link in a forward direction (−Y); a condition wherein the handle pushes a rear surface of the link in the forward direction; a condition of including an elastic member that comes into contact with the pusher and pushes the pusher in the forward direction; and/or a condition of including an elastic member that comes into contact with the pusher and pushes the pusher in the forward direction, wherein a center line of the elastic member is above a center line of a gasket.

Selectively, the refrigerator may satisfy at least one of a condition wherein at a contact portion between the handle and the link, a slip length of the link is smaller than a thickness of the link; a condition wherein at the contact portion between the handle and the link, the slip length of the link is longer than a slip length of the handle; a condition wherein the contact portion between the handle and the link passes through an extension line of the second axis when the handle moves; a condition wherein a thickest portion among the link and the handle is provided on the handle; a condition wherein a distance between the contact portion and the first axis is greater than a distance between the contact portion and the second axis; a condition wherein the contact portion moves in the forward direction (−Y) when the handle and the link operate; a condition wherein the link has a first area close to the second axis and a second area far from the second axis, the first area being thicker than the second area; and/or a condition wherein a length of the handle is longer than a length of the link.

Selectively, the refrigerator may include a first pressing part, in the handle, to which an external force is applied with respect to the first axis, a second pressing part, in the handle, adjacent to the link with respect to the first axis, a third pressing part adjacent to the handle on the link with respect to the second axis, and a fourth pressing part adjacent to the pusher on the link with respect to the second axis, and may satisfy at least one of a first condition wherein a thickness/length of the link of the third pressing part is greater than that of the fourth pressing part, and/or a second condition wherein when a point where an external force is applied to the first pressing part is defined as a point of action (A), and a contact portion (C) of the handle and the link, a distance between the point of action and the contact portion is provided to be shorter than a distance between the point of action and the first axis.

Selectively, the refrigerator may satisfy at least one of: a condition of having a first virtual axis in a front-rear direction (Y) with respect to the first axis, and a second virtual axis in an up-down direction (Z) with respect to the first axis, wherein the second axis is closer to the second virtual axis than the first virtual axis, or the second axis passes through the second virtual axis; a condition of having a first virtual axis in a front-rear direction (Y) with respect to the first axis, and a second virtual axis in an up-down direction (Z) with respect to the first axis, wherein when the first virtual axis is an X-axis and the second virtual axis is a Y-axis to provide a quadrant, a contact point between the handle and the link is placed in at least one of a first quadrant and a second quadrant; a condition of providing a shortest virtual line connecting the first axis and the second axis, wherein an angle formed by the virtual line with respect to a front-rear direction (Y) is greater than an angle formed by the virtual line with respect to an up/down direction (Z) ; and/or a condition of providing a shortest virtual line connecting the first axis and the second axis, wherein a point where an external force is applied to the first pressing part is defined as a point of action, of providing a contact portion of the handle and the link, and of providing a second virtual line connecting the point of action and the contact portion, wherein a length of the first virtual line is longer than a length of the second virtual line.

Selectively, the handle may have a first area provided high in the center portion. The handle may include a second area provided lower than the first area on both sides of the first area. The second area may be shorter in the extension direction of the door than the first area. The second area may have reinforcing ribs provided more densely than the first area.

Selectively, the refrigerator may include a first axis supporting the rotation of the handle; a second pressing part that is provided at a certain position of the handle and presses the link; and a fourth pressing part that is provided at a certain position of the link and presses the pusher. The second pressing part and the fourth pressing part may be located in the same temperature area.

Selectively, the refrigerator may include at least two pushers that receive the external force to separate the door and the cabinet. At least one of the at least two pushers may be located in the center area of the door, when the door is divided into three equal parts in the left-right direction. The pushers may be provided symmetrically in the left-right direction of the door. The pusher may be located adjacent to a dividing point, when the door is divided into three equal parts in the left-right direction. The pusher may be located adjacent to a second dividing point and a fourth dividing point from any one end, when the door is divided into six equal parts in the left-right direction. The pusher may be located in a third area and a fourth area from any one end, when the door is divided into six equal parts in the left-right direction (X).

Selectively, the refrigerator may include a cabinet providing a storage space; a door opening and closing the storage space; and an open module that initially opens the door. The open module may include a contact member to which an external force is applied when the door is opened. The open module may include at least two pushers that receive the external force to separate the door and the cabinet. The open module may include a handle that is interposed between the contact member and the pusher and rotates, and a case that accommodates at least a portion of the handle.

Selectively, the door may include an outer panel that defines the outer side of the door and has a certain gap from the case; and an inner panel that defines the inner side of the door and has a certain gap from the case. The refrigerator may include a cap fastened to the open module. The cap may be fastened to at least one of the inner panel and the outer panel. A foam member may be filled in at least one of a space between the inner panel and the case and a space between the outer panel and the case. The internal area of the case may have a vertical length greater than a front-rear length. The internal area may have a vertical length that is twice a front-rear length or more.

Selectively, the refrigerator may include a heat diffusion plate provided adjacent to the lowest temperature point to prevent frost formation at the lowest temperature point where the cap and the case meet. The lowest temperature point may be provided to a branching portion of the cap and the case.

Selectively, the refrigerator may include an insulating gap accommodating the open module. The refrigerator may include a dike that is provided long in the front-rear direction of the door to provide an energy nose to the inner panel providing the insulating gap. The insulating gap and the isotherm provided to the open module may have a portion that slopes inward as it goes toward the lower side of the door. The dike may be longer in the up-down direction of the door than in the front-rear direction of the door. The lower end of the inner surface of the dike may extend further downward than the lower end of the open module. The insulating gap may include an insulating wall area and an energy nose area. A pressing part of the handle may be placed in the insulating gap.

### Advantageous Effects

According to the present invention, the open module can be miniaturized. This miniaturization of the open module can lead to lower product prices, expanded product applications, and improved reliability.

According to the present invention, the open module can be narrowed in the front-rear direction. Accordingly, a greater insulation effect can be achieved with the same insulation wall size.

According to the present invention, the frost formation due to temperature difference in the narrow wall can be prevented.

According to the present invention, stable interlocking between members can be ensured. Therefore, multiple mechanical operations can be performed stably.

According to the present invention, a driving force greater than the force applied by a user can be obtained. Accordingly, the reliability of door opening can be improved.

The problems, solutions, and effects of the present invention can be described in more detail in the embodiments of the present invention.

### DESCRIPTION OF DRAWINGS

FIG. 1 is a perspective view of a refrigerator according to a first embodiment.

FIG. 2 is an exploded perspective view of a door.

FIG. 3 is a detailed exploded perspective view of an open module according to the first embodiment of FIG. 2.

FIG. 4 is a drawing showing the open module and the cap that are mounted on an outer panel and an inner panel.

FIG. 5 is a perspective view illustrating the operation of the open module.

FIG. 6 is a drawing illustrating a configuration of the pressing part.

FIG. 7 is a side cross-sectional view of the open module comparing the before and after operation of the open module.

FIG. 8 is a drawing showing a fastening process of the open module.

FIG. 9 is a drawing comparing the internal area.

FIG. 10 is a perspective view of a refrigerator according to a second embodiment.

FIG. 11 is an exploded perspective view of a door according to the second embodiment.

FIG. 12 is a detailed exploded perspective view of an open module according to the second embodiment of FIG. 11.

FIG. 13 is a drawing showing the open module and the cap that are mounted on an outer panel and an inner panel.

FIG. 14 is a perspective view illustrating the operation of the open module with the cover and case that are removed.

FIG. 15 is a drawing illustrating the operation of a handle in the open module according to the second embodiment.

FIG. 16 is a perspective view illustrating the operation of the pusher according to the second embodiment.

FIG. 17 is a drawing sequentially illustrating the assembly sequence of a door according to the second embodiment.

FIG. 18 is a reference drawing illustrating a fastening process of the open module.

FIG. 19 is a drawing showing each portion of the open module according to the second embodiment.

FIG. 20 is a drawing showing the relationship between an axis, a handle, and a link.

FIG. 21 is a drawing illustrating another embodiment combining the first and second embodiments.

FIG. 22 is a cross-sectional view showing a cap recess according to a third embodiment.

FIG. 23 is a surface drawing of an outer panel including unevenness to explain the effect of the third embodiment.

FIG. 24 is a drawing testing the insulation effect around the open module in a refrigerator according to a fourth embodiment.

FIG. 25 is a drawing illustrating a configuration for preventing frost formation due to cold air on a door of a refrigerator according to the fourth embodiment.

FIG. 26 is a drawing comparing the thickness of the door of the fifth embodiment with that of a comparative example.

FIG. 27 is a drawing comparing the thickness of a door of a sixth embodiment with the thickness of a comparative example.

FIG. 28 is a perspective view of a part related to a handle applicable to the sixth embodiment.

FIG. 29 is a side cross-sectional view of a door showing a positional relationship between a first axis and a second axis of a refrigerator according to a seventh embodiment and an eighth embodiment.

FIG. 30 is a side cross-sectional view of a door showing a positional relationship between a first axis and a second axis of a refrigerator according to a ninth embodiment and a tenth embodiment.

FIG. 31 is a perspective view of a refrigerator according to an eleventh embodiment.

### MODE FOR INVENTION

Hereinafter, specific embodiments of the present disclosure will be described in detail with reference to the drawings. However, the present disclosure is not limited to the following embodiments, and those skilled in the art who understand the concept of the present disclosure will be able to easily propose other embodiments included within the scope of the same concept by adding, changing, deleting, and supplementing components, and this may also be included within the scope of the present disclosure. In the description of drawings, identical or similar components may be assigned identical or similar reference numerals regardless of drawing symbols, and redundant descriptions thereof may be omitted. In the case of a pair of members provided in a left-right/up-down/front-rear direction, etc. one member may be described while the description of the other member may be omitted. One of the members may have A at the end of the drawing number, and the other member may have B at the end of the drawing number. In this case, the Arabic numerals for the pair of members may be the same. In general, suffixes such as “module” and “unit” may be used to refer to elements or components. Use of such suffixes herein is merely intended to facilitate description of the specification, and the suffixes do not have any special meaning or function. In the present disclosure, that which is well known to one of ordinary skill in the relevant art has generally been omitted for the sake of brevity. The accompanying drawings are used to assist in easy understanding of various technical features and it should be understood that the embodiments presented herein are not limited by the accompanying drawings. As such, the present disclosure should be construed to extend to any alterations, equivalents and substitutes in addition to those which are particularly set out in the accompanying drawings. It will be understood that although the terms first, second, etc. may be used herein to describe various elements, these elements should not be limited by these terms. These terms are only used to distinguish one element from another. It will be understood that when an element is referred to as being “connected with” another element, there may be intervening elements present. In contrast, it will be understood that when an element is referred to as being “directly connected with” another element, there are no intervening elements present. A singular representation may include a plural representation unless context clearly indicates otherwise. In the present application, it should be understood that the terms “comprises, includes,” “has,” etc. specify the presence of features, numbers, steps, operations, elements, components, or combinations thereof described in the specification, but do not preclude the presence or addition of one or more other features, numbers, steps, operations, elements, components, or combinations thereof. A component included in one embodiment may be applied to other embodiments. This enables the provision of further embodiments. In one embodiment, the same component may be applied to the description of embodiments and a description thereof may be omitted. Members having the same or similar roles in each embodiment may be assigned the same number to facilitate understanding. Even members having the same number in each embodiment may not be identical. For example, the shape, degree of function, operational state, and direction may different from each other. In this case, a description of the member may be added. In the description of the present disclosure, direction may be a relative concept. For example, in the description of the present disclosure, direction may be based on four directions with respect to 90 degrees. To face a certain direction may imply that a certain direction is more adjacent. For example, facing the right (+X) may mean facing a range of −45 to +45 degrees with respect to the X-axis. For example, in the description of the present disclosure, direction may be based on two directions with respect to 180 degrees. To face a certain direction may imply that a certain direction is more adjacent. For example, facing the right (+X) may mean facing a range of −90 to +90 degrees with respect to the X-axis.

### First Embodiment

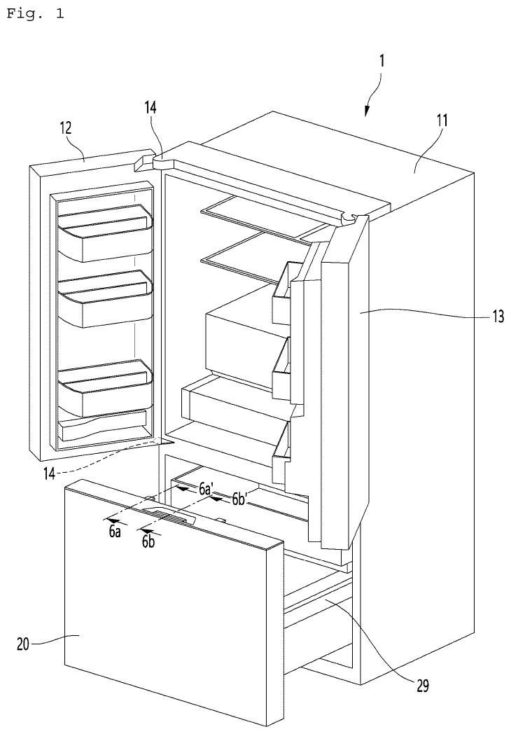

FIG. 1 is a perspective view of a refrigerator according to a first embodiment. Referring to FIG. 1, a refrigerator 1 may include a cabinet 11 forming a storage space. The refrigerator may include a door 12, 13, 20 for opening and closing the storage space. The refrigerator may include a warming compartment.

The storage space of the cabinet 11 may be partitioned by a barrier. The storage space may be partitioned vertically. A refrigerator compartment may be formed in the upper portion. A freezer compartment may be formed in the lower portion. The door may include a first door 12, 13 for opening and closing the refrigerator compartment on the left and right sides. The first door may rotate around a hinge 14 as a supporting axis. The door may include a second door 20 for opening and closing the freezer compartment. The first door may be mounted to the cabinet 10 by the hinge 13. The first door may open and close the refrigerator compartment by rotating. The second door 20 may be slidably mounted to the cabinet 11. During the sliding operation, the cabinet may be inserted or withdrawn. The freezer compartment may be opened and closed by the insertion and withdrawal of the second door 20. The second door 20 may include a basket on the rear surface of the door. The second door 20 may be referred to as a drawer-type door 20. The refrigerator of the embodiment may include other types of an opening/closing door. The refrigerator of the embodiment may include a combination of various types of opening/closing door.

The first door 12, 13 may be provided with a contact member. The second door 22 may be provided with a contact member. An external force may be directly applied to the contact member. An external force may be indirectly applied to the contact member. A user may operate the door through the contact member. By operating the contact member, the door may be withdrawn from the cabinet. For example, the contact member may open the door by overcoming at least one of a door load, a differential pressure between the inside and outside of refrigerator, and/or a magnetic force of a gasket. In this case, the door opening may refer to an initial opening.

The door opening will be described. The door opening may include an initial opening and a non-initial opening. The initial opening may refer to the initial opening when the door begins to open. The non-initial opening may refer to the door opening after the initial opening is terminated. The door load may act as a resistance force against the initial opening and the non-initial opening. The resistance force may be defined as a force that resists the door from opening. The differential pressure between the inside and outside of refrigerator may significantly affect the beginning of the initial opening. After the beginning of the initial opening, the resistance force caused by the differential pressure between the inside and outside of refrigerator may rapidly disappear. The magnetic force of the gasket may be fully applied during the initial opening. The magnetic force of the gasket may gradually decrease throughout the entire period of the initial opening.

The contact member may provide a force that overcomes the resistance force of the initial opening. For example, the actuation of the contact member may enable to achieve the initial opening of the door and cabinet. For example, users may perform the initial opening by operating the contact member with their fingers. Then, user's arm may operate the door. A user may perform actions such as contacting, grasping, pushing, pulling, and/or pressing the contact member. Instead of or in addition to the user, an automatic mechanism may actuate the contact member. The contact member may be provided at the corners of the first and second doors. The contact member may be provided at the upper end portion of the second door. A rail 29 may be provided at the rear of the second door. The rail may guide the insertion and withdrawal of the second door.

The embodiment exemplifies a bottom-freeze type refrigerator with a freezer compartment located in a lower portion. This concept may be applied to other types of refrigerators. This concept may also be applied to other types of doors.

The following embodiment illustrates the provision of the contact member to the second door as an example. In the following description, when referring to a door, the second door may be considered first. Obviously, the door may also be the first door.

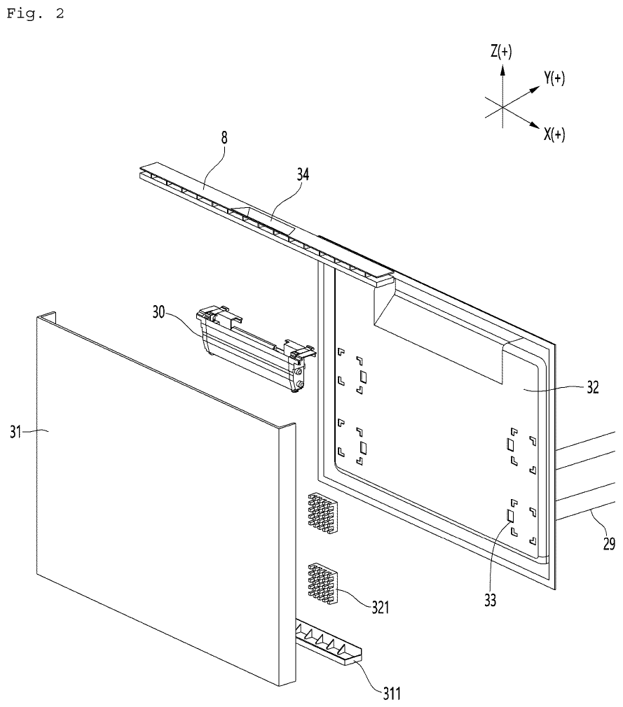

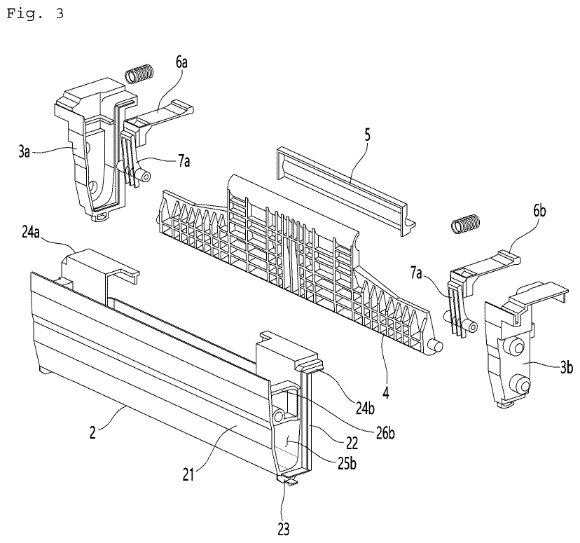

FIG. 2 is an exploded perspective view of the door illustrated in FIG. 1. FIG. 3 is a detailed exploded perspective view of an open module according to the first embodiment of FIG. 2. Referring to FIGS. 2 and 3, the door may include an outer panel 31 facing the outside of the cabinet, and an inner panel 32 facing the inside of the cabinet. The outer panel may be made of a metal material. The inner panel may be made of a resin material. The inner panel may be a door liner. The door may include a bottom 311 protecting the lower portion. Both side surfaces of the door may be protected by a portion extending from one of the panels. For example, both side ends of the outer panel may include a wing. A cap 8 protecting the upper surface of the door may be included. The cap 8 may include a cap recess 34. The cap recess may have a concave structure into which a user's hand enters. The cap recess may accommodate at least a portion of the contact member. The cap recess 34 may be recessed downward of the cap. The cap recess may include a portion recessed downward of the door. An pen module 30 capable of interlocking with the contact member may be included. The open module 30 may accommodate at least a portion of the contact member.

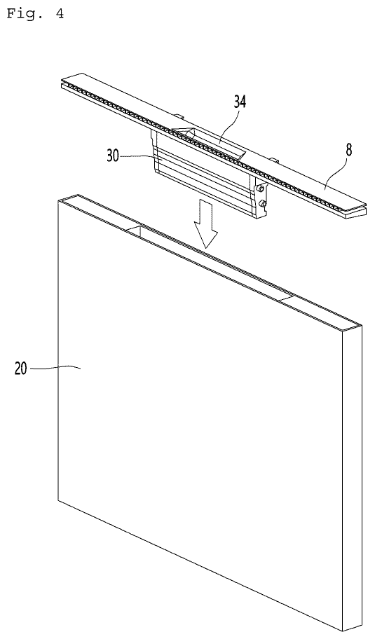

FIG. 4 is a drawing showing the open module and the cap that are mounted on the outer panel and the inner panel. Referring to FIG. 4, the open module 30 and the cap may be fastened to provide a first assembly. The outer panel, the inner panel, and the bottom may be fastened to provide a second assembly. The second assembly may be fastened to the upper surface of the second assembly. This configuration may provide an insulating space within the door.

This will be described with reference to FIGS. 2 to 4. The inside of the door may be filled with a foam member. The foam member may be filled in an internal space defined by the rear of the outer panel, the front of the inner panel, the upper side of the bottom, the lower side of the cap, and the left and right sides facing the inside of the door viewed from the wing. The foam member may be filled in the external space of the open module 30. The foam member may not be filled in the internal space of the open module 30. The foam member may be filled between the open module 30 and the outer panel, between the open module 30 and the inner panel, between the open module 30 and the bottom, between the open module 30 and the cap, and/or between the open module 30 and the wing. The foam member may be made of a resin material, polystyrene (PS), and/or a porous material. Instead of or in addition to the foam member, a vacuum insulating member may be applied.

The cap 8 may be fastened to at least one of the inner panel and/or the outer panel. The cap may be fastened to at least one of the inner panel and/or the outer panel while the open module 30 is fastened. The cap may be fastened to the upper end of at least one of the inner panel and/or the outer panel. The cap may be fastened to at least one of the inner panel and/or the outer panel with a protrusion and a groove. The inner panel and the outer panel may have upper ends having the same height. The inner panel and the outer panel may not provide a recessed portion and/or a protruding portion in the front-rear direction (Y) for fastening the cap. The inner panel and the outer panel may not provide a recessed portion and/or a protruding portion in the up-down direction (Z) for fastening the cap. A foam member may be filled in at least one of a gap between the cap and the inner panel and/or a gap between the cap and the outer panel. The cap and the open module 30 may be firmly positioned against the door by the foam member.

The left-right direction of the door may be defined as an X-axis direction. The inward-outward direction of the door may be defined as a Y-axis. The up-down direction of the door may be defined as a Z-axis direction. A rail 29 may extend inwardly of the inner panel 32. A certain fastening member may fasten the rail to the inner panel. A certain fastening member may fasten the rail mount to the rail. A rail mount 321 may be fastened to the inner panel. The rail mount may firmly fasten the rail to the inner panel. By the rail mount, even if the door thickness (length in the Y-axis direction) is thin, the rail may be strongly fixed to the inner panel. The rail mount 321 may be aligned with the rail recess 33.

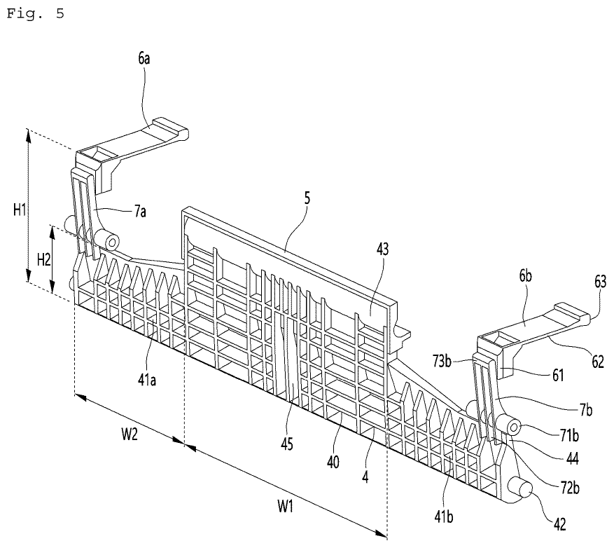

The open module 30 may initially open the door by utilizing the operation of the contact member. FIG. 5 is a perspective view illustrating the operation of the open module. FIG. 5 is a drawing of the open module with the cover and case that are removed.

Referring to FIGS. 3 and 5, the open module 30 may include the contact member. The open module 30 may include a grip 5 with which a user makes contact. The contact member may be the grip 5. The open module 30 may include a handle 4. The grip may come into contact with the handle 4. The grip may be fastened to the handle 4. If there is no grip, the handle 4 may serve as the contact member. A member that initiates the operation of the open module 30 under the action of an external force may be referred to as a contact member.

When the grip moves forward (−Y), the handle 4 may rotate. The handle 4 may rotate in a first direction around a first axis 42. The handle 4 may rotate the link 7. The link 7 may rotate in a second direction around a second axis 71. The first and second directions may be an opposite direction. The link 7 may push the pusher 6 rearward (+Y). The pusher 6 and the cabinet may perform an action/reaction motion. When the pusher 6 pushes the cabinet, the door may be initially opened. Here, the cabinet may include a member that does not move, unlike the door operation.

The open module 30 according to the first embodiment will be described in detail.

The open module 30 may include a handle 4 to which an external force is applied. The handle 4 may have a portion extending in the up-down direction (Z). The handle 4 may have a first area 40 at the center of the handle 4. A grip 5 may be provided in the first area 40. An external force may be applied to the first area. The handle 4 may have a second area 41a 41b on the lateral side of the first area 40. A lateral length w1 (length in the X direction) of the first area may be greater than a lateral length w2 of the second area. By lengthening the lateral length w1 of the first area, the twisting of the handle 4 may be reduced. The twisting of the handle 4 may occur when the handle 4 is rotated. The twisting of the handle 4 may occur significantly as the grip 5 and the pusher 6 are farther apart in the left-right direction (X). In order to further reduce the twisting of the handle 4, a plurality of reinforcing ribs 45 may be provided on the handle 4. The reinforcing ribs may be denser in the second area than in the first area. Accordingly, the twisting of the handle 4 may be further reduced. The height h1 (Z-direction length) of the first area may be greater than the height h2 of the second area. The height of the first area may be set high so that an external force may be applied. The height of the first area may be high so that a large force may be obtained with a small external force based on the principle of a lever. According to the force amplification of the lever, a user may operate the handle 4 with a small external force. A first axis 42 may be provided on the lower side of the handle 4. The first axis 42 may extend in the left-right direction (X-direction). The upper portion of the first area may be a first pressing part 43. The upper portion of the second area may be a second pressing part 44. When the first pressing part 43 is pushed, the handle 4 may rotate around the first axis 42. When the handle 4 rotates, the second pressing part 44 may push the link 7. The cover 3 may support the first axis 42. The cover may support the handle 4 on the lateral side of the first axis 42.

The link 7a, 7b may be positioned on the left and right sides of the handle 4, respectively. The link 7 may rotate around the second axis 71a, 71b. The link 7 may include a third pressing part 72a, 72b placed below the second axis 71. The link 7 may include a fourth pressing part 73a, 73b placed on the upper side of the second axis 71. The third and fourth pressing parts may have a portion extending in the up-down direction (Z). The third and fourth pressing parts may provide a reinforcing rib. The reinforcing rib may prevent deformation of the link 7. The lengths of the third and fourth pressing parts may be different from each other. A lever action may be performed by adjusting the lengths of the third and fourth pressing parts. For example, the third pressing part 72 may be made shorter than the fourth pressing part 73. In this case, even if the third pressing part 72 moves a short distance, the fourth pressing part 73 may move further. Through this, the movement distance of the pusher 6 may be secured. The second pressing part 44 may push the third pressing part 72. When the second pressing part 44 is pushed, the link 7 may rotate around the second axis 71. When the link 7 rotates, the third and fourth pressing parts may rotate together. The fourth pressing part 73 may push the pusher 6a, 6b. At least one link 7 may be provided. Two links 7 may be provided. A pair of links 7 may be provided on the left and right sides of the handle 4. The link 7 may initially open the door with a balanced force. One end of the second axis 71a, 71b may be supported by the cover 3. The other end of the second axis 71a, 71b may be supported by a case.

The pusher 6a, 6b may be placed between the open module 30 and the cabinet 11. The pusher 6 may include an action/reaction point of the door and the cabinet. The pusher 6 may have an outer end 61 extending in the up-down direction (Z). The outer end may maintain mutual contact even when the position changes during rotation of the fourth pressing part 73. The pusher 6 may have an extension portion 62 extending in the front-rear direction (Y). The extension portion may lengthen the action length of the pusher 6. The rear end of the extension portion may have an inner end 63. The inner end may be in contact with the cabinet 11. When the pusher 6 is pushed rearward, the inner end may push the cabinet. The inner end may be referred to as a pushing end. The front-rear length of the extension portion may be longer than the vertical length of the outer end. The height of the inner end may be longer than the height of the extension portion. The fourth pressing part 73 may push the outer end. When the outer end is pushed, the pusher 6 may move rearward as a whole. The cover 3a, 3b may guide the pusher 6. The cover may be provided with at least one rib to guide the operation of the pusher 6. The rib may extend in the front-rear direction (Y). The force applied to the pusher 6 may be amplified by a first lever action of the handle 4 and a second lever action of the link 7. The movement distance of the pusher 6 may be secured by the first lever action of the handle 4 and the second lever action of the link 7.

The first pressing part 43 and the fourth pressing part 73 may be placed in an upward direction +Z with respect to the first rotation axis. The first pressing part 43 and the fourth pressing part 73 may be placed in the same direction with respect to the first rotation axis. The first pressing part 43 and the fourth pressing part 73 may be placed in the upward direction +Z with respect to the second rotation axis. The first pressing part 43 and the fourth pressing part 73 may be placed in the same direction with respect to the second rotation axis. The first pressing part 43 may be a pressing part where an external force is initiated. The fourth pressing part 73 may be a pressing part that finally pushes the pusher 6. The second pressing part 44 and the third pressing part 72 may be placed in the upward direction +Z with respect to the first rotation axis. The second pressing part 44 and the third pressing part 72 may be placed in the downward direction-Z with respect to the second rotation axis. The first rotation axis may be placed in the downward direction than the second rotation axis. Depending on the above configuration, the width of the open module 30 in the front-rear direction Z may be reduced. Accordingly, the front wall of the door may be configured to be thin. Accordingly, the insulation length of door in the front-rear direction may be increased. Accordingly, the insulation effect may be enhanced. Accordingly, the internal volume of the refrigerator may be increased.

The grip 5 may be placed on at least one of the upper and/or rear portions of the handle 4. A user may easily access the grip. The external force acting on the grip may be amplified by the first and second lever actions. For example, the door may be initially opened even with a small force applied by a user. The door may be initially opened with small grip strength of fingers. Only the grip strength of hand may be applied during the initial opening. The force of an arm, other than fingers, may not be applied during the initial opening. The ratio of the movement distance of the handle 4 to the movement distance of the pusher 6 may be adjusted for the first and second lever actions. Consequently, the external force applied by a user to the handle 4 and the movement distance of the handle 4 may correspond to the force applied by the pusher 6 to the cabinet and the movement distance of the cabinet. The rotational action of the handle 4 may be transformed into the translational action that the pusher 6 pushes the cabinet.

The case 2 may accommodate at least a portion of the handle 4. The case may guide the operation of the handle 4. The case may guide the position of the handle 4. The case may include an outer support plate 21 providing a front (−Y) wall. The case may include an inner support plate 22 providing a rear wall. The case may include a lower support plate 23 providing a lower wall. The lower support plate may connect the lower portions of the inner support plate and the outer support plate in a front-rear direction. The lateral side of the case may include an open gap 25. The second area 41 may be laterally withdrawn through the open gap. A shafting 26 may be included above the open gap 25. The axle may support the second axis 71. The shafting may include a cylindrical structure supporting the inner side of the second axis 71. The upper portion of the case may be opened. The handle 4 may be assembled through the upper portion of the case. The upper portion of the inner support plate 22 may include a fitting 24a, 24b extending rearward (+Y). The fitting may guide the position of the open module 30 and the cap 8. For example, the open module 30 and the cap may be assembled by the fitting. The fitting 24 may guide the operation of the pusher 6.

The cover 3 may be provided on the left and right sides of the case. The cover may shield the internal space of the case 2 from the outside. The inflow of the foam member may be blocked through the cover. The cover may have a shafting supporting the first and second axiss. The cover may guide the operation of the pusher 6.

The second axis 71 may be positioned at the front side (−Y) compared to the first axis 42. The second axis 71 may be positioned at the upper side (+Z) compared to the first axis 42. The second axis 71 may be closer to a user than the first axis 42. Accordingly, the user's grip 5 may be closer to a user. A user may more conveniently operate the open module 30. A user may operate the grip with less force.

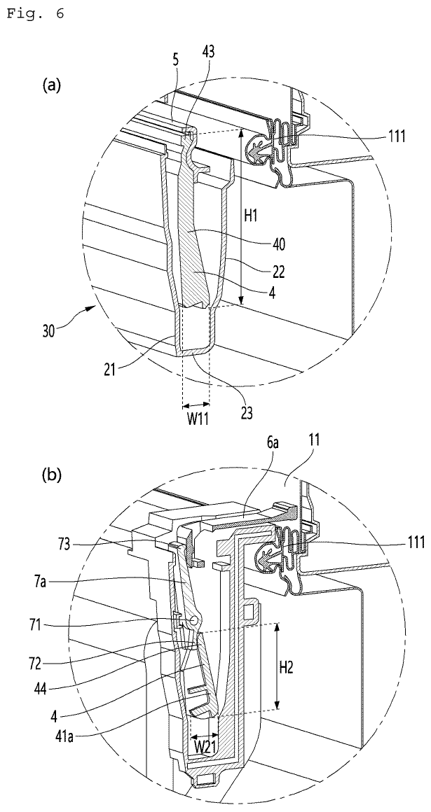

FIG. 6 is a drawing illustrating the configuration of the pressing part. FIG. 6A is a cross-sectional perspective view of 6a-6a′ of FIG. 1. FIG. 6B is a cross-sectional perspective view of 6b-6b′ of FIG. 1. FIG. 6B is a cross-sectional perspective view of 6b-6b′ of FIG. 1.

The operation of the pressing part will be described with reference to FIG. 6. In a stationary state, at least one of the handle 4 and/or the link 7 may come into contact with at least one of the inner support plate 22, the outer support plate 21, and/or the cap 8. In a stationary state, the handle 4 may come into contact with at least one of the cap 8 and/or the inner support plate 22. In a stationary state, the link 7 may come into contact with the outer support plate 21. By the action of an external force, the grip 5 may push the first pressing part 43. The first pressing part 43 may rotate. The first pressing part 43 and the second pressing part 44 may rotate in the same direction. The second pressing part 44 may push a third pressing part 72. The second pressing part 44 and the third pressing part 72 may rotate in different directions. The third pressing part 72 may rotate. The third pressing part 72 and the fourth pressing part 73 may rotate in the same direction. The pressing part may rotate around the first and second axiss as described. The fourth pressing part 73 may push the pusher 6. The pressing end 63 of the pusher 6 may push the cabinet. The pressing end may push the partition wall of the storage compartment. The cabinet may refer to the outermost panel of the cabinet. The pressing end may push the outside of the gasket 111.

The thickness w11 of the first area 40 and the thickness w12 of the second area 41 may be provided to be the same. The ratio (h1/w11) of the thickness w11 and height h1 of the first area 40 may be greater than the ratio (h2/w12) of the thickness w12 and height h2 of the second area 41. Accordingly, the twisting of the second area may be further reduced. When the handle 4 is operated, a greater moment may occur in the second area than in the first area.

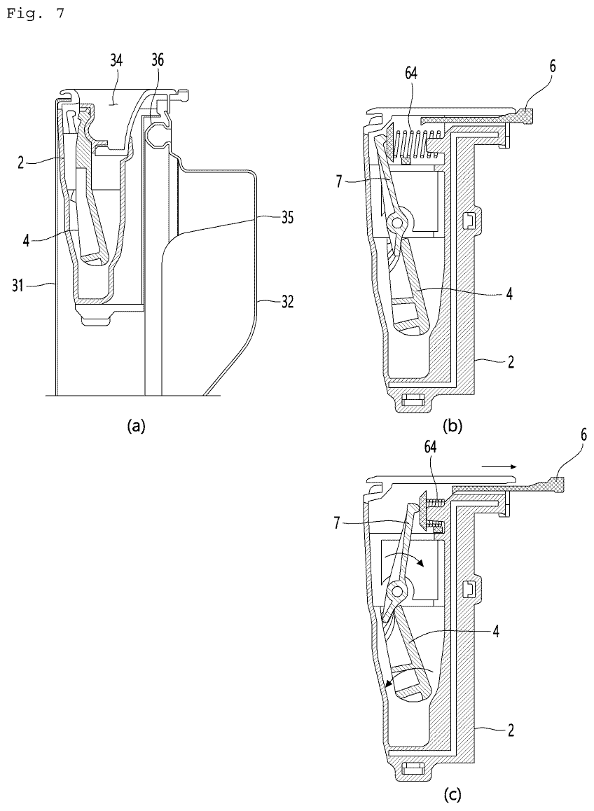

FIG. 7 is a side cross-sectional view of the open module comparing the before and after operation of the open module. FIGS. 7A and 7B may be in a stationary state, and FIG. 7C may be in an operating state. FIG. 7A may correspond to FIG. 6A. FIGS. 7B and 7C may correspond to FIG. 6B.

Referring to FIG. 7, when the open module 30 operates, the handle 4 may rotate counterclockwise around the first axis 42. When the open module 30 operates, the link 7 may rotate clockwise around the second axis 71. When the open module 30 operates, the pusher 6 may move forward. An elastic member 64 controlling the operation of the pusher 6 may be provided. The elastic member may return the pusher 6 to a stationary state. The elastic member may be interposed between the outer end 61 of the pusher 6 and the cover 3.

A gasket recess 36 may be provided at the lower side of the cap recess 34. The gasket 111 may be fixed to the gasket recess 36. A dike 35 may be provided at the rear (+Y) of the open module 30. The dike may reinforce the insulation thickness of the wall increased by the open module 30. The dike may provide an energy nose (EN). The energy nose may block airflow in the storage space to enhance the insulation effect.

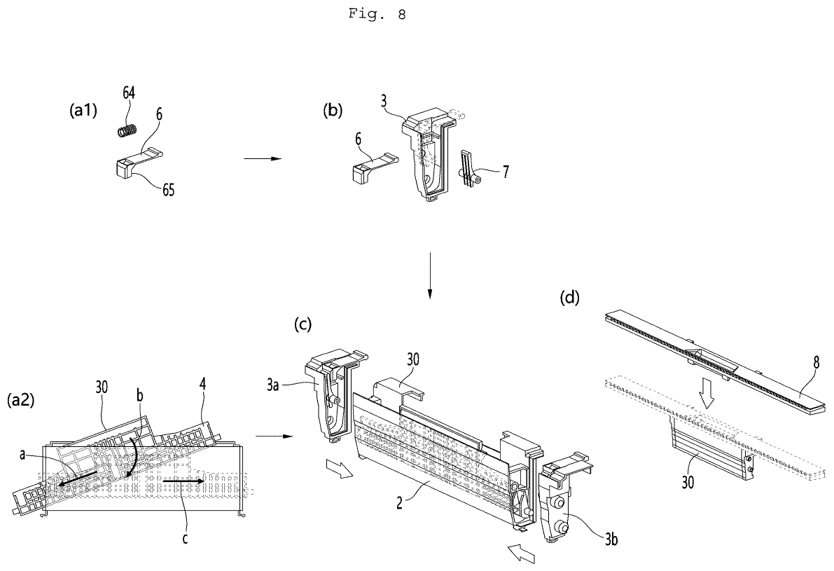

FIG. 8 is a drawing showing the fastening process of the open module. Each drawing of FIG. 8 shows the fastening of each component.

Refer to FIG. 8. FIG. 8A1 shows the fastening of the elastic member 64 to the pusher 6. The elastic member may guide the stop position of the pusher 6. The elastic member may pull or push the pusher 6 in a forward direction (−Y). FIG. 8A2 shows the fastening of the handle 4 to the case 2. FIG. 8B shows the fastening of the pusher 6 to the cover 3 and the fastening of the link 7 to the cover. The operation of the pusher 6 may be guided by the cover. The elastic member may be interposed between the pusher 6 and the cover. At least a portion of the link 7 may be placed at the front (−Y) of the pusher 6. One side of the second axis 71 of the link 7 may be supported by the cover. A state in which each member is fastened to the cover may be referred to as a cover assembly.

FIG. 8A2 shows that the left second area 41a of the handle 4 moves deeply to the left through the left (−X) open gap 25a. At this time, the handle 4 may be tilted upward to the right. The grip may be fastened to the handle 4. Thereafter, the handle 4 may be aligned horizontally. The handle 4 may be moved to the right. Through this motion, the left second area 41a of the handle 4 may move to the right through the left open gap 25a. By this action, the second right area 41b of the handle 4 may move to the right through the open gap 25a on the right +X. Through this process, the handle 4 may be aligned in a correct position within the case. The part in which the handle 4 is placed on the case may be referred to as a handle 4 assembly.

FIG. 8C is a drawing showing that the cover assembly and the handle 4 assembly are fastened. Two assemblies may be fastened by fitting a protrusion and a recess. The cover may be fastened at both sides of the case 2. The first axis 42 may be supported by the cover. The second axis 71 may be supported by the cover. The first axis 42 may be supported only by the cover. Each of the second axiss 71 may be supported by the cover and the case.

FIG. 8D is a drawing showing that the open module 30 and the cap are fastened. The cap may be fastened to the upper end of the open module 30. The cap may be fastened to the link 7. The cap may be fastened to the fitting. Each member may be fastened by fitting a protrusion and a recess. The cap recess 34 and the grip 5 may be aligned in a correct position. A single body in which the cap and the open module 30 are fastened may be fastened to the panel 31, 32. The single body may be fixed by the fastening of the cap 8 to the panel 31 32. The open module 30 may not be fixed to the panel. The inner support plate 22 may not be in contact with the panel 31, 32. Then, as shown in FIG. 4 and its description, it may be fastened to the door 20.

The internal area where the case 2 and the cap 8 are placed may be referred to as an internal area. A foam member may not be provided in the internal area. The open module 30 may be placed in the internal area.

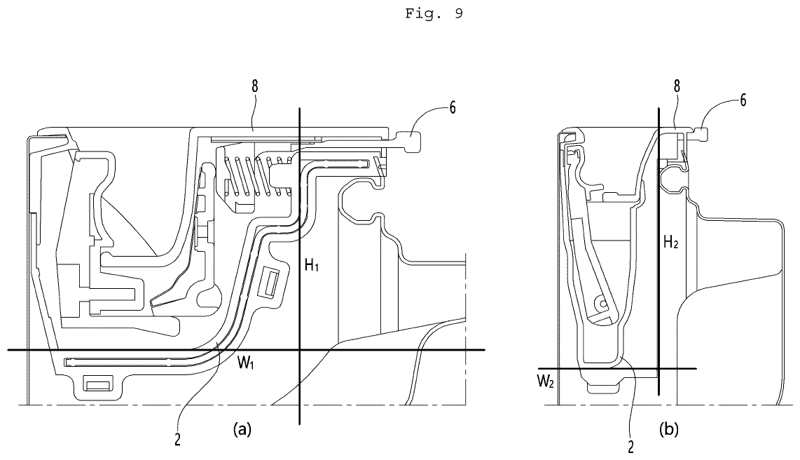

FIG. 9 is a drawing comparing the internal areas. The internal area may be based on the largest point in the front-rear and up-down directions. FIG. 9A is a drawing showing the internal area of a comparative example, and FIG. 9B is a drawing showing the internal area of an embodiment. The comparative example and the embodiment may be a configuration necessary to operate a door having the same size and weight.

Refer to FIG. 9. In the internal area of the comparative example, a ratio (W1/H1) of the size H1 in the up-down direction (Z) to the size W1 in the front-rear direction (Y) may be greater than 1. In the internal area of the embodiment, a ratio (W2/H2) of the size H2 in the up-down direction (Z) to the size W2 in the front-rear direction (Y) may be less than 1. In the internal area of the embodiment, a ratio (W2/H2) of the size H2 in the up-down direction (Z) to the size W2 in the front-rear direction (Y) may be less than 0.5. According to this ratio, the thickness of the internal area in the front-rear direction may be reduced. Accordingly, the door thickness may be reduced. A thinner door provides a larger storage space, and may satisfy user's esthetic sense

### Second Embodiment

Hereinafter, a refrigerator according to a second embodiment will be described. The refrigerator according to the second embodiment may differ from other embodiments in terms of the open module and related configuration.

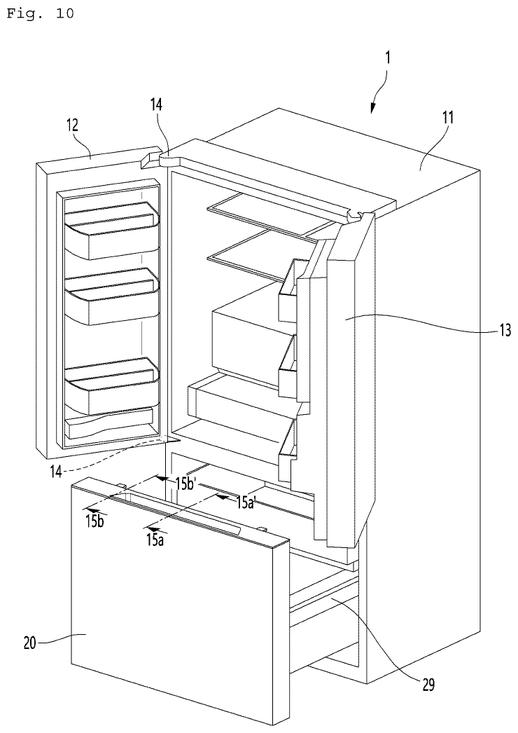

FIG. 10 is a perspective view of a refrigerator according to the second embodiment.

Refer to FIG. 10. A refrigerator 1 may include a cabinet 11 forming a storage space. The refrigerator may include a door 12, 13, 20 for opening and closing the storage space. The refrigerator may include a warming chamber. The first door may rotate around a hinge 14 as a support axis. The door may include a second door 20 for opening and closing the storage compartment. The second door 20 may be slidably mounted on the cabinet 11.

The second door may be provided with a pusher 6. The second door may be provided with at least two pushers 6. The installation position of the pusher 6 may be movable to the left-right ends of the door, compared to the first embodiment. The pusher 6 may overlap at least a portion of the rail mount 321 in the up-down direction. The pusher 6 and the rail mount 321 may not overlap in the up-down direction. In this case, the pusher 6 and the rail mount 321 may be adjacent to each other compared to the first embodiment. The rail mount may overlap the rail 29 in the front-rear direction. The pushing action of the pusher 6 may be directly applied to the rail. Here, the direct application may refer to no or small moment in the left-right direction (X). The pushing action of the pusher 6 may be directly applied to a load. Here, the load may refer to a rail supporting the door and contained items. Accordingly, the door 20 may be opened smoothly. This action may be caused by the rotational direction of the second axis 71a, 71b being parallel to the Z-axis and/or the link 7a, 7b moving toward the left-right ends of the door. Details of the link 7 and the second axis 71 will be described later.

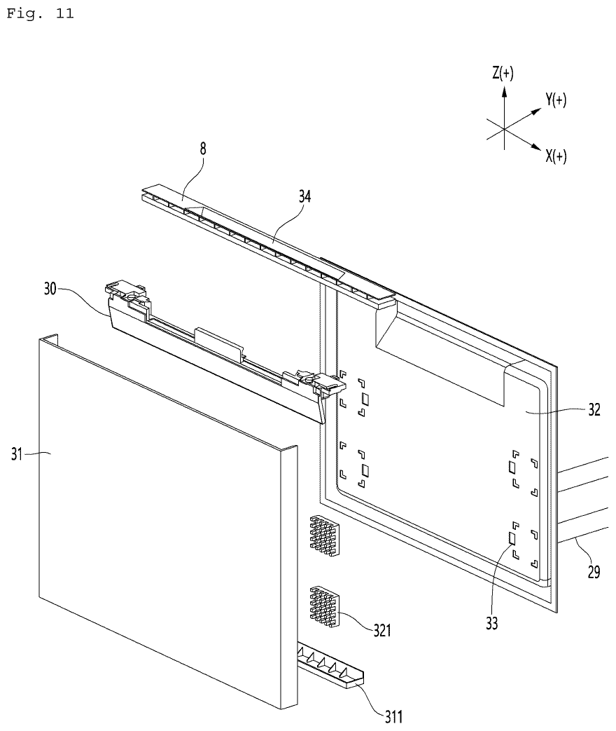

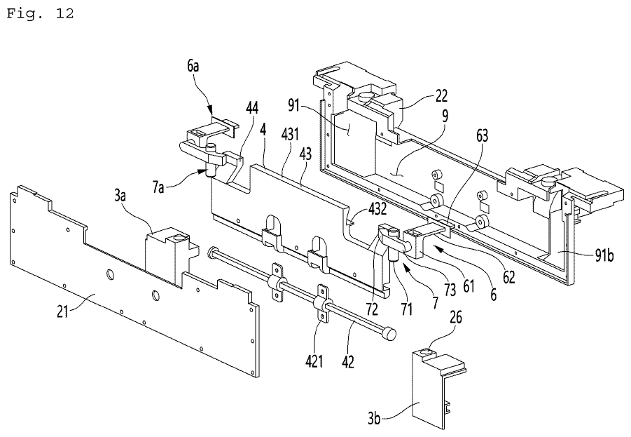

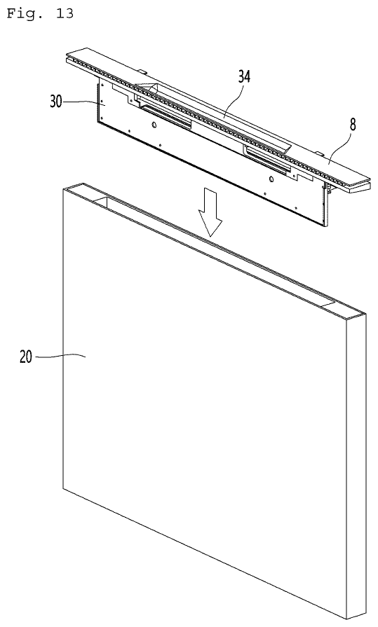

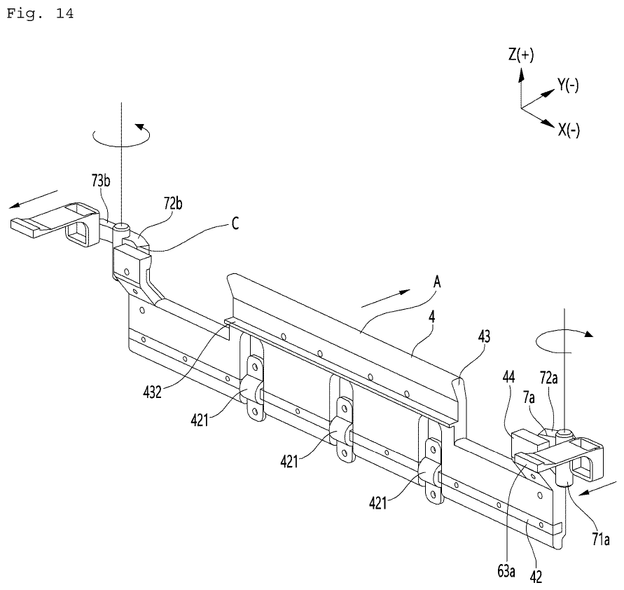

FIG. 11 is an exploded perspective view of a door according to the second embodiment. FIG. 12 is a detailed exploded perspective view of the open module according to the second embodiment of FIG. 11. FIG. 13 is a drawing showing that the open module and the cap are mounted on the outer and inner panels. FIG. 14 is a perspective view illustrating the operation of the open module with the cover and case that are removed.

Refer to FIGS. 11 to 14. The cap recess 34 may be provided longer in the left-right direction compared to the first embodiment. When the cap recess is provided longer in the left-right direction, user accessibility may be improved. Users may access not only the center of the door, but also anywhere in the wide cap recess in one direction.

The open module 30 and the cap may be fastened to provide a first assembly. An outer panel, an inner panel, and a bottom may be fastened to provide a second assembly. The second assembly may be fastened to the upper surface of the second assembly. The interior of the door may be insulated by a foam member and a vacuum insulating member. The open module 30 may initially open the door by the action of the contact member.

The contact member may move in a forward direction (−Y) by an external force. The handle 4 may rotate by the external force. The handle 4 may rotate in a first direction with respect to a first axis 42. The first axis 42 may extend in the left-right direction (X). The first direction may be a rotational direction with the left-right direction (X) as a central axis. The handle 4 may rotate the link 7. The link 7 may rotate in a second direction with respect to a second axis 71. The second axis 71 may extend in the up-down direction (Z). The second direction may be a rotational direction with the up-down direction (Z) as a central axis. The first direction and the second direction may be directions intersecting each other. The first direction and the second direction may be orthogonal directions. The link 7 may push the pusher 6 in a rearward direction (+Y). The pusher 6 and the cabinet may perform an action/reaction movement. When the pusher 6 pushes the cabinet, the door may be initially opened.

The open module 30 according to the second embodiment will now be described in detail.

The open module 30 may include a handle 4 to which an external force is applied. The handle 4 may have a portion extending in the up-down direction (Z). The handle 4 may have a first area 40 at the center of the handle 4. The handle 4 may have a second area 41 on the lateral side of the first area 40. The handle 4 may be provided with a plurality of reinforcing ribs 45.

A first pressing part 43 may be provided on the upper portion of the first area. The first pressing part 43 may include a vertical portion 431 extending in the up-down direction. The vertical portion 431 may be a portion with which a user's finger directly comes in contact. A horizontal portion 432 may be provided approximately in the middle or lower portion of the vertical portion. The installation height of the vertical portion may vary depending on the depth or shape of the cap recess. The horizontal portion may extend in a rearward direction (+Y) from the rear surface of the vertical portion. The horizontal portion may have a certain length in the left-right direction. The horizontal portion may extend along the upper surface of the lower wall of the cap recess 34. The horizontal portion may block the inflow of external substances into the interior of the open module 30. At least a portion of the horizontal portion may come in contact with the wall of the cap recess. The horizontal portion may slide along the wall of the cap recess.

A second pressing part 44 may be provided at the upper portion of f the second area. When the first pressing part 43 is pushed, the handle 4 may rotate about the first axis 42. The handle 4 may rotate about the first direction as a central axis. The first axis 42 may be fastened to the lower portion of the handle 4. The first axis 42 may be fastened to the inner support plate 22 by the first axis 42 mount 421. The first axis 42 mount and the inner support plate may be fastened to each other by a fastening tool. Here, the fastening tool may be a screw. The handle 4 may be fixed to the inner support plate 22 by the first axis 42 mount. Both ends of the first axis 42 may be supported by the cover 3a, 3b. The cover 3 may support the handle 4 on both sides of the first axis 42.

When the handle 4 rotates, the second pressing part 44 may push the link 7. The link 7 may rotate around the second axis 71. The link 7 may be supported by the cover. The link 7 may be supported by the support plate. The link 7 may be supported by the inner support plate. The second axis 71 may extend in the up-down direction (Z). The second axis 71 may intersect with the first axis 42. The link 7 may extend in the left-right direction (X). The links 7a, 7b may include a third pressing part 72 provided on the inner portion of the link 7. The link 7 may include a fourth pressing part 73 provided on the outer portion of the link 7. By providing the fourth pressing part 73 on the outer side of the link 7, the pusher 6 may be positioned further outward. Here, the inside and outside of the link 7 may be set by using the center of the open module 30 as a reference. If there is no description on a reference for the inside and outside, the center of the open module 30 may be used as a reference. The third pressing part 72 and the fourth pressing part 73 may be adjacent to an extension end of the link 7. The fourth pressing part 73 may push the pushers 6a, 6b.

The pusher 6a, 6b may be placed between the open module 30 and the cabinet 11. The pusher 6 may have an outer end 61 extending in the up-down direction (Z). The pusher 6 may have an extension portion 62 extending in the front-rear direction (Y). The rear end of the extension portion may have an inner end 63. The cover 3a, 3b may guide the pusher 6.

The second pressing part 44 and the third pressing part 72 may be placed inward with respect to the second axis 71. The fourth pressing part 73 may be placed outward with respect to the second axis 71. The first axis 42 and the second axis 71 may extend in directions intersecting with each other. The first axis 42 and the second axis 71 may extend in directions orthogonal to each other. Accordingly, the pusher 6 may be positioned further outward. Accordingly, the pusher 6 and the rail mount may overlap with or be adjacent to each other in the up-down direction. Accordingly, the front wall of the door may be configured to be thin. Accordingly, the insulation length may be increased. Accordingly, the insulation effect may be enhanced. Accordingly, the internal volume of the refrigerator may be increased. Accordingly, a user may conveniently open the door with less force.

The case may have a support plate. The support plate may include an inner support plate 22 and an outer support plate 21. The inner support plate 22 may provide a recess 9 that is recessed in a rearward direction (+Y). The recess 9 may accommodate at least a portion of the handle 4. An opening portion 91 that is opened may be provided at both left and right ends of the recess. The opening portion may be closed by the cover 3. The rear surface of the outer support plate 21 may be fastened to the front surface of the inner support plate 22. The open module 30 may be shielded from the outside by the outer support plate, the inner support plate, and the cover. Accordingly, the inflow of the foam member may be blocked.

The cover 3 may include a shafting. The shafting may support at least one of the first axis 42 and/or the second axis 71. The shafting may include a shafting 27 of the first axis 42 having a portion extending in the left-right direction. The shafting of the first axis 42 may support the first axis 42. The shafting may include a shafting 26 of the second axis 71 having a portion extending in the up-down direction. The shafting of the second axis 71 may support the second axis 71.

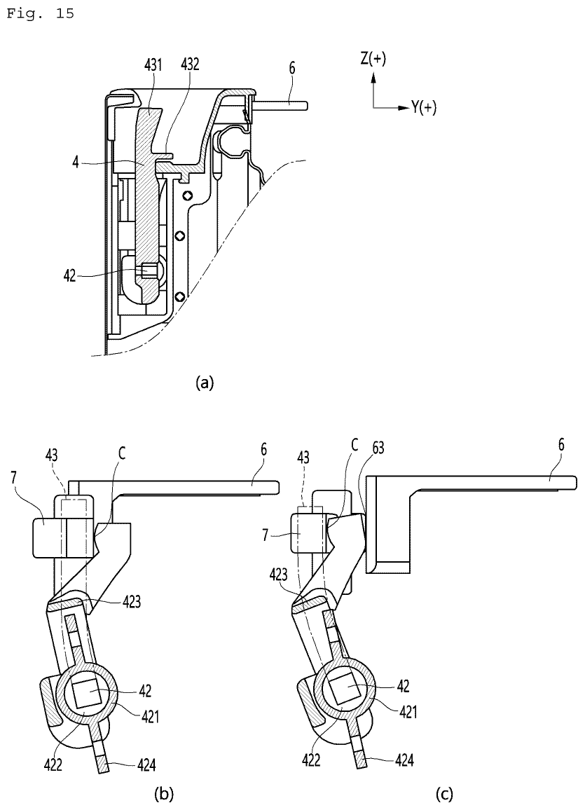

FIG. 15 is a drawing illustrating the operation of the handle in the open module according to the second embodiment. FIG. 15A is a cross-sectional view taken along line 15a-15a′ in FIG. 10, FIG. 15B is a cross-sectional view taken along line 15b-15b′ in FIG. 10 before the pusher operates, and FIG. 15C is a cross-sectional view taken along line 15b-15b′ in FIG. 10 after the pusher operates.

Refer to FIG. 15. An external force may rotate the handle 4 counterclockwise. The handle 4 may rotate around the first axis 42 extending in the left-right direction. During the rotation of the handle 4, the second pressing part 44 and the third pressing part 72 may come into contact with each other. The link 7 may rotate around the second axis 71. The fourth pressing parts may push the pusher 6 in a rearward direction (+Y).

A bearing 422 supporting the first axis 42 may be provided. The bearing may be provided outside the first axis 42. The first axis 42 mount 421 may support the bearing. The bearing may freely rotate between the first axis 42 and the first axis 42 mount. The bearing may slide between two members. The bearing may slide with respect to any one adjacent member. The first axis 42 may have a non-circular cross-section in the axial direction. The first axis 42 may have a square cross-section in the axial direction. The first axis 42 may rotate together with the handle 4. Even if the handle 4 and the first axis 42 rotate, the first axis 42 mount may not rotate. The first axis 42 mount 421 may be fastened to the support plate. The support plate may be an inner support plate 22. The first axis 42 mount 421 may include a housing 423 that supports the bearing. The first axis 42 mount 421 may include a wing 424 extending outward from the housing 423. The wing may be fastened to the support plate. Here, a screw may be used as the fastening member.

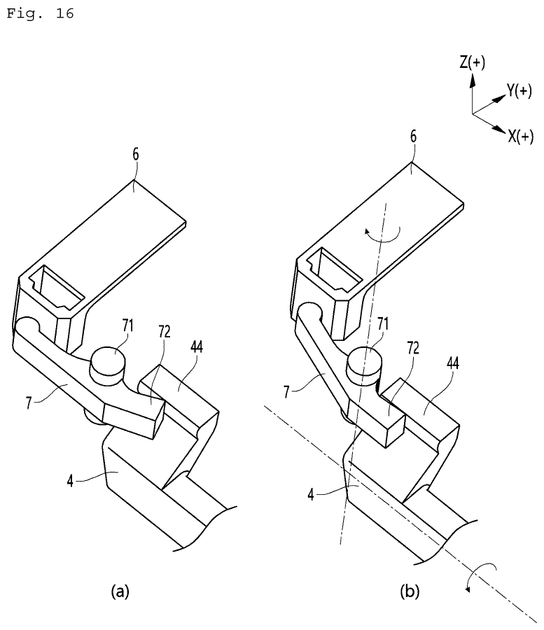

FIG. 16 is a perspective view illustrating the operation of the pusher according to the second embodiment. FIG. 16A is a drawing before the pusher operates, and FIG. 16B is a drawing after the pusher operates.

Refer to FIGS. 15 and 16. The handle 4 may rotate counterclockwise around the first axis 42. The second pressing part 44 of the handle 4 may push the third pressing part 72 of the link 7 in a forward direction (−Y). The link 7 may rotate clockwise with respect to the second axis 71. The link 7 may extend in the left-right direction (X). The third pressing part 72 and the fourth pressing part 73 may be spaced apart from each other in the left-right direction (X). The fourth pressing part 73 may move to be biased toward the outside of the open module 30. The fourth pressing part 73 of the link 7 may push the pusher 6 in a rearward direction (+Y). The pusher 6 may push the cabinet. The door 20 may be initially opened by the pusher 6.

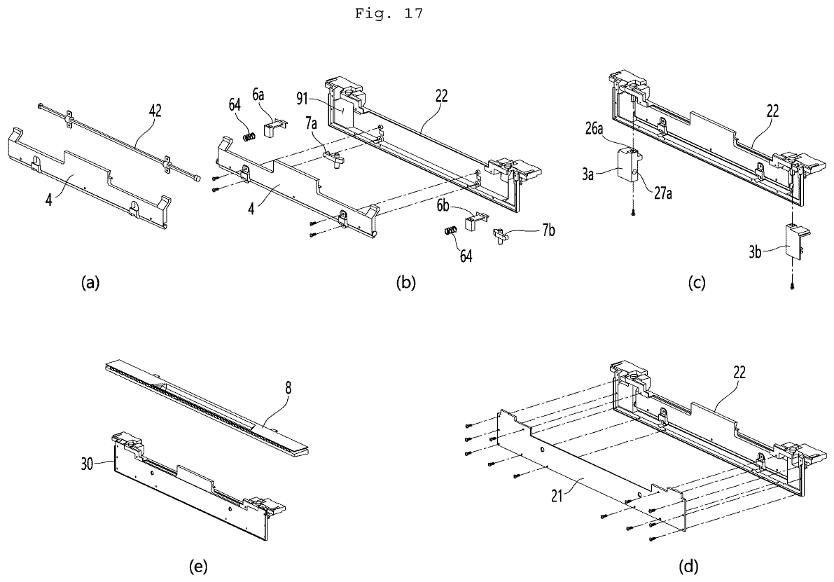

FIG. 17 is a drawing sequentially illustrating the assembly sequence of a door according to the second embodiment. FIG. 17A is a drawing showing the fastening between the handle and the second axis, FIG. 17B is a drawing showing the fastening between the inner support plate and the handle, FIG. 17C is a drawing showing the additional fastening of a cover, FIG. 17D is a drawing showing the additional fastening of the outer support plate, and FIG. 17E is a drawing showing the additional fastening of a cap.

Refer to FIG. 17A. First, the first axis 42 may be seated on the handle 4. The seating of the first axis 42 and the handle 4 can be seen in FIGS. 17A and 17B.

Refer to FIGS. 17A and 17B. A first axis 42 mounting portion 441 on which the first axis 42 is placed may be provided at the lower portion of the handle 4. At least a portion of the first axis 42 mounting portion 441 may have the same shape as a cross-section of the first axis 42. The first axis 42 mounting portion may have a rectangular cross-section. The first axis 42 mounting portion may be provided to extend in the left-right direction (X). A mount recess 443 may be provided at a position where the first axis 42 mount 421 is placed. The mount recess may be concave in a forward direction (−Y) of the handle 4. The mount recess may accommodate at least a portion of the first axis 42 mount. The mount recess may restrict the rocking of the first axis 42 mount. When the first axis 42 is placed on the first axis 42 mounting portion 441 and the first axis 42 mounting is placed on the mount recess 443, the mounting of FIG. 17A may be terminated.

Refer to FIG. 17B. The inner support plate and the handle 4 may be fastened. The handle 4 may be fastened in a state of being able to rotate with respect to the inner support plate. The first axis 42 mount 421 may be fastened to the inner support plate 22. A fastening member may be fastened in a rearward direction (+Y). The fastening member may fasten the wing 424 and the inner support plate 22. The bearing may be interposed between a connection portion of the first axis 42 and the inner support plate. The first axis 42 and the handle 4 may rotate together. The inner support plate may permit the rotation of the handle 4.

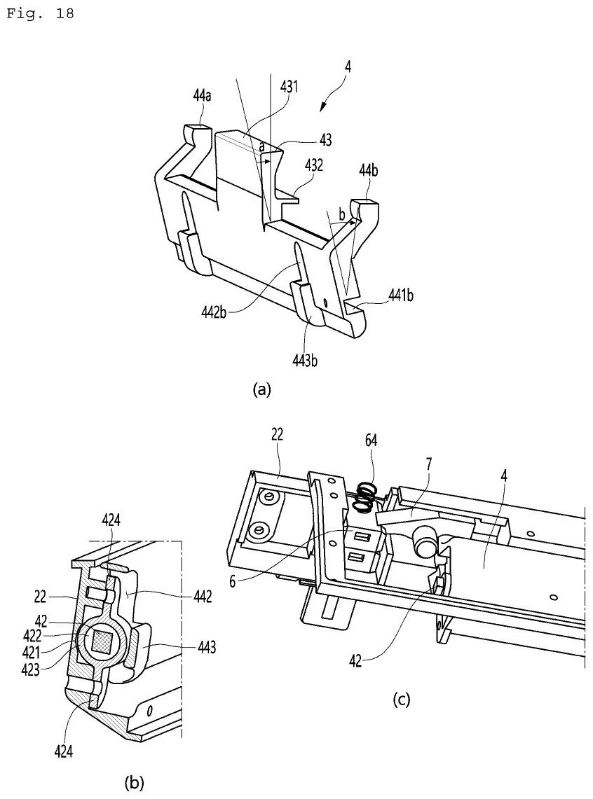

The pusher 6 may be placed on the inner support plate. The pusher 6 may be temporarily assembled to the inner support plate. An elastic member 64 may be interposed between the pusher 6 and a contact portion of the inner support plate. The elastic member may push the pusher 6 in a forward direction (−Y). The elastic member may guide the default position of the pusher 6. The elastic member may guide the default positions of the handle 4 and the link 7. The link 7 may be placed on the inner support plate. The link 7 may be temporarily assembled to the inner support plate. The inner support plate may provide a shafting for the second axis 71 of the link 7. The mounting of the pusher 6 and the link 7 can be seen in FIG. 18c. Referring to FIG. 18C, an elastic member 64 may be provided on one surface of the pusher 6. The upper portion of the second axis 71 may be supported on the inner support plate of the link 7.

Refer to FIG. 17C. A cover 3a, 3b may be fastened to the inner support plate 22. A first surface of the cover may include a shafting 26 of second axis 71 supporting the lower end of the second axis 71. Here, the first surface of the cover may be an upper surface of the cover. A second surface of the cover may include a first axis 42 shafting 27 supporting the distal end of the second axis 71, 42. The second surface may be a side surface of the cover. Here, the side surface may be an inner surface facing the center of the handle 4. A third surface of the cover may guide the pusher 6. The third surface may guide the lower surface of the pusher 6. A fourth surface of the cover may close the opening portion 91 of the inner support plate. The fourth surface of the cover may include the second surface of the cover. The fourth surface may include the front surface (−Y) of the cover. In the inner support plate, all surfaces of wall surface may be closed by the cover. The foam liquid inside the inner support plate may not flow in.

Refer to FIG. 17D. The outer support plate 21 may be fastened to the inner support plate 22. The support plate may be fastened by screws. The external foam member may not flow into the inner space of the inner support plate and the outer support plate. Refer to FIG. 16E. The cap 8 may be fastened to the open module 30. Thereafter, the module may be fastened to the door.

FIG. 18 is a reference drawing explaining the fastening process of the open module. FIG. 18A is a perspective view of the handle 4, FIG. 18B is a cross-sectional view of the first axis 42 mount cut along a YZ plane, and FIG. 18C is a bottom perspective view before the cover is fastened. Refer to FIG. 18. The first pressing part 43 and the second pressing part 44 of the handle 4 may be bent in a forward direction (+Y) at a certain angle. The bending angle (a) of the first pressing part 43 is smaller than the bending angle (b) of the second pressing part 44. Depending on the configuration, the open module 30 may be configured within a narrow range in the front-rear direction (Y).

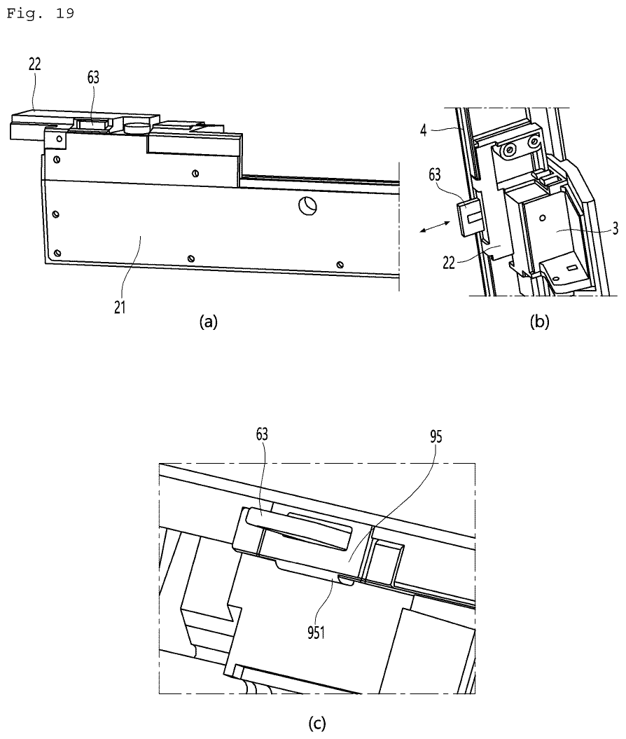

FIG. 19 is a drawing showing each part of the open module according to the second embodiment. FIG. 19A is a front perspective view of the outer end of the pusher, FIG. 19B is a bottom perspective view of the outer end of the pusher with a protective cap not installed, and FIG. 19C is an enlarged view showing the protective cap installed.

Refer to FIG. 19. The internal space of the open module 30 may be blocked from the outside by the inner support plate, the outer support plate, and the cover. The movement of the pusher 6 may be guided by the inner support plate and the cover. The pusher 6 may be inserted and withdrawn in the front-rear direction (Y). The pusher 6 may be inserted and withdrawn at a relatively long length. A protective cap 95 that guides the insertion and withdrawal of the outer end 63 of the pusher 6 may protect the outer end of the pusher 6. The outer end 63 may be inserted and withdrawn through a narrow slit of the protective cap 95. The internal area of the slit may be almost identical to the cross section of the outer end. The internal area of the slit may be slightly larger than the cross section of the outer end. The protective cap 95 may be fixed by fastening the fastening rib 951 to at least one of the inner support plate, cover, and/or cap. Alternatively, a separate fastening member may be used for fastening. The inflow of external foreign matter through the slit may be prevented. Product failure may be prevented.

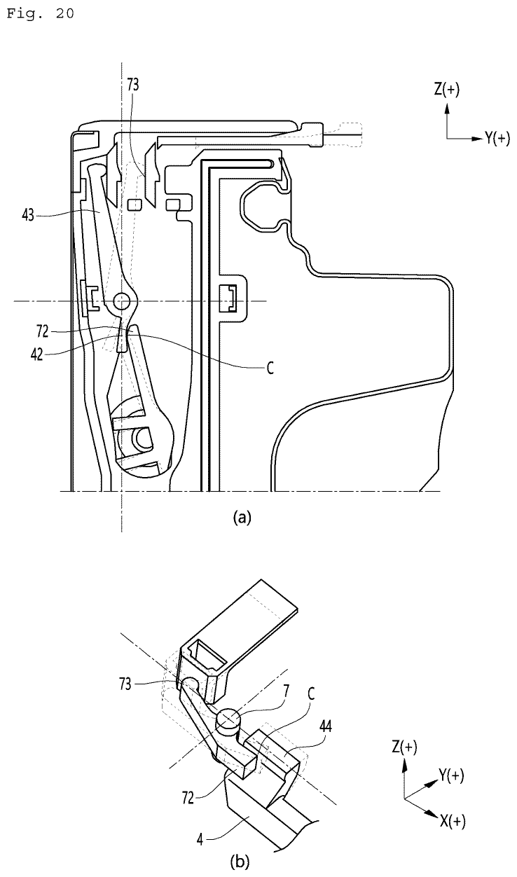

FIG. 20 is a drawing showing the relationship between the shaft, the handle, and the link. FIG. 20A shows the operation of the handle, the link, and the pusher in the first embodiment, and FIG. 20B shows the operation of the handle, the link, and the pusher in the second embodiment.

Refer to FIGS. 20 and 15. The open module 30 of the present invention may achieve miniaturization, particularly, a reduction in thickness in the front-rear direction. By applying the configuration, it is possible to prevent the frost forming, secure stable interlocking between members, and secure a large initial force. To achieve the above-described effects, the present invention has the following operational characteristics. The following description may be identical in the first and second embodiments. Additional explanations will be provided in other cases.
1. The handle 4 may push the link 7 in the pulling direction of the handle 4. The handle 4 may push the link 7 in a forward direction (−Y). The second pressing part 44 may push the third pressing part 72 in a forward direction. Due to the above force action, the thickness of the open module 30 in the front-rear direction (Y) may be reduced.
2. The front surface (−Y surface) of the handle 4 may push the rear surface (+Y surface) of the link 7 in a forward direction (−Y). The front surface of the second pressing part 44 may push the rear surface of the third pressing part 72. Due to the interaction of the above force, the open module 30 may be configured more compactly.
3. Based on the contact portion (C) of the handle 4 and the link 7, the slip length, which is the amount of slip between two members, may be defined. The slip length of the link 7 is smaller than the thickness of the link 7. The thickness of the link 7 may denote the thickness of a cross-section cut normal to the extension direction of the second axis 71. The link 7 has a length, and the direction perpendicular to the length may be defined as a thickness. The thickness of the link 7 may refer to the thickness of the link 7 in the YZ plane in the first embodiment. The YZ plane may refer to the normal plane of the X-axis. The same applies below. The thickness of the link 7 may refer to the thickness of the link 7 in the XY plane in the second embodiment. As the slip length decreases, damage to the member due to friction may be prevented. Reliable operation of the accessed member may be achieved.
4. The contact portion (C) of the handle 4 and the link 7 may pass beyond the second axis 71 when the handle 4 is operated. Before the operation of the handle 4 and the link 7, the contact portion may be placed at the front (+Y) with respect to the second axis 71. After the operation of the handle 4 and the link 7, the contact portion may be placed at the rear (−Y) with respect to the second axis 71. Here, the front and rear may be set as the front (+Y) or rear (−Y) with respect to the XZ plane including the second axis 71. The XZ plane may be the same in the first embodiment and the second embodiment. By changing the position of the contact portion before and after the operation of the handle 4 or before and after the operation of the link 7, the slip length may be provided to be further smaller. Accordingly, damage to the member may be prevented and the operation reliability between the members may be improved.

The slip length may occur in both the link 7 and the handle 4. That is, the slip length of the link 7 and the slip length of the handle 4 may occur. In an embodiment, the slip length of the link 7 may be longer than the slip length of the handle 4. This may be because the position of the contact portion of the link 7 passes beyond the second axis 71.
5. The thickness/length (thickness divided by length) of the link 7 may be provided to be greater on the fourth pressing part 73 side than on the third pressing part 72 side. In other words, the aspect ratio of the fourth pressing part 73 may be smaller than the aspect ratio of the third pressing part 72. Here, the thickness and length may be based on a virtual rectangle that accommodates both the third pressing part 72 and the fourth pressing part 73. In the first embodiment, the thickness and length of the link 7 may refer to the thickness and length of the link 7 in the YZ plane. In the second embodiment, the thickness and length of the link 7 may refer to the thickness and length of the link 7 in the XY plane. According to the above configuration, the force amplification due to the lever action may be performed significantly and stably.
6. The thickest part of the handle 4 and the link 7 may be provided on the handle 4. The handle 4 may transmit external force to both the left and right ends. It is preferable that the handle 4 have a thickness sufficient to withstand bending stress. To this end, a plurality of reinforcing ribs may be provided. The reinforcing ribs may make the thickness of the handle 4 in the front-rear direction (Y) greater than that of the link 7. Accordingly, stable operation of the open module 30 can be induced. Accordingly, dimensional errors that may occur during operation can be minimized.
7. A first virtual axis in the front-rear direction (Y) based on the first axis 42 and a second virtual axis in the up/down direction (Z) based on the first axis 42 are provided. In the first embodiment, the second axis 71 may be closer to the second virtual axis than to the first virtual axis. In the second embodiment, the second axis 71 may pass through the second virtual axis. In the second embodiment, the second axis 71 may be parallel to the first virtual axis. When the first axis 42 and the second axis 71 have a certain range, the second axis 71 may overlap with the first virtual axis in the second embodiment. By the above configuration, the open module 30 may be configured compactly
8. The handle 4 may rotate in a first direction around the first axis 42. The link 7 may rotate in a second direction around the second axis 71. In the first embodiment, the handle 4 and the link 7 may rotate in an opposite direction. The handle 4 may rotate clockwise (+X) with respect to the left-right direction (X), and the link 7 may rotate clockwise (+X) with respect to the left-right direction (X). In the second embodiment, the handle 4 and the link 7 may rotate in different directions. In the second embodiment, the handle 4 and the link 7 may rotate in intersecting directions. In the second embodiment, the handle 4 may rotate clockwise (+X) with respect to the left-right direction (X), and the link 7 may rotate clockwise (+Z) with respect to the up-down direction (Z). The open module 30 may be provided in a narrow space by the rotational direction of the handle 4 and link 7 described above.
9. A first virtual axis in the front-rear direction (Y) based on the first axis 42 and a second virtual axis in the up-down direction (Z) based on the first axis 42 are provided. The first virtual axis as x-axis and the second virtual axis as Y-axis may provide a quadrant. For example, a YZ plane may be provided based on the first axis 42 and a quadrant may be provided. At this time, the contact portion (C) of the handle 4 and the link 7 may be placed in at least one of a first quadrant and/or a second quadrant. In the first embodiment, the contact portion may be placed in the second quadrant. In the second embodiment, the contact portion may move the first quadrant and the second quadrant. By the above configuration, a narrow open module 30 in the front-rear direction (Y) may be provided. The open module 30 of the embodiment may be narrow in a width in the front-rear direction (Y), and long in the up-down direction (Z). The open module 30 of the embodiment may have a length in the up-down direction (Z) greater than a thickness in the front-rear direction (Y).
10. A contact portion (C) between the handle 4 and the link 7 is provided. At this time, the distance between the contact portion and the first axis 42 may be greater than the distance between the contact portion and the second axis 71. Here, the distance may be measured based on the YZ plane. In this manner, force amplification by the handle 4 may be induced. Accordingly, an open module 30, which is greater in an up-down direction than in an up-down direction, may be provided. Consequently, a compact open module 30 may be provided.
11. A contact portion (C) between the handle 4 and the link 7 is provided. At this time, the contact portion may move forward (−Y) during operation of the open module 30. By moving the contact portion, the open module 30 may be provided in a narrow space.
12. The link 7 may have a first area close to the second axis 71 and a second area farther from the second axis 71. The first area may be thicker than the second area. This configuration prevents deformation of the member when an external force is applied. Accordingly, force transmission of precise distance and direction may be achieved.
13. The total length of the handle 4 may be longer than the total length of the link 7. Here, the length may be based on the YZ plane. By providing the handle 4 long, the amplification of force by the handle 4 may be significantly induced. By ensuring that the handle 4 is sufficiently elongated in one direction, the open module 30 may be provided in a compact size.
14. The point (see A of FIG. 13) where an external force is applied to the first pressing part 43 is referred to as a point of action. This is referred to as the contact portion (C) between the handle 4 and the link 7. The distance between the point of action (A) and the contact portion (C) may be shorter than the distance between the point of action and the first axis 42. Here, the length may be based on the YZ plane. According to this configuration, the external force applied to the point of action may be amplified and applied to the link 7. Accordingly, the initial opening may be achieved even with a smaller force.
15. A virtual line connecting the first axis 42 and the second axis 71 is provided. The first virtual line may represent the shortest distance between the two shafts. For example, in the second embodiment, the virtual line may be included in the YZ plane. The angle formed by the virtual line with respect to the front-rear direction (Y) may be greater than the angle formed by the virtual line with respect to the up/down direction (Z). The virtual line may be close to a standing position. Here, the Standing position may be based on the YZ plane. As described above, the center of motion of the handle 4 and the link 7 may be arranged in the up/down direction Z. In this case, the open module 30 may be configured to be narrow in the front-rear direction. It should be noted that the front-rear direction refers to the thickness direction of the door. Accordingly, a thinner door may be provided.
16. A first virtual line connecting the first axis 42 and the second axis 71 is provided. The first virtual line may represent the shortest distance between the two shafts. For example, in the second embodiment, the virtual line may be included in the YZ plane. The point where an external force is applied to the first pressing part 43 is referred to as a point of action (A). A contact portion (C) between the handle 4 and the link 7 is provided. A second virtual line connecting the point of action and the contact portion is provided. All of the virtual lines may be based on the YZ plane. The length of the first virtual line may be longer than the length of the second virtual line. According to this configuration, each contact portion may be arranged in one direction. Accordingly, an open module 30 that is long in the up-down direction may be provided.
17. The elastic member may come into contact with one surface of the pusher 6 and one surface of the support plate. In the first embodiment, the elastic member may push the pusher 6 in a forward direction (−Y). Accordingly, the accurate operation of the pusher 6 may be guided. The elastic member 64 is provided horizontally, thereby accurately guiding the operation of the pusher 6.
18. The centerline of the elastic member 64 may be above the centerline of the gasket 111. The center of gravity of the elastic member 64 may be placed upward (+Z) than the center of gravity of the gasket. According to this configuration, the pusher 6 and the gasket may operate without interference. By this configuration, a compact open module 30 may be configured.

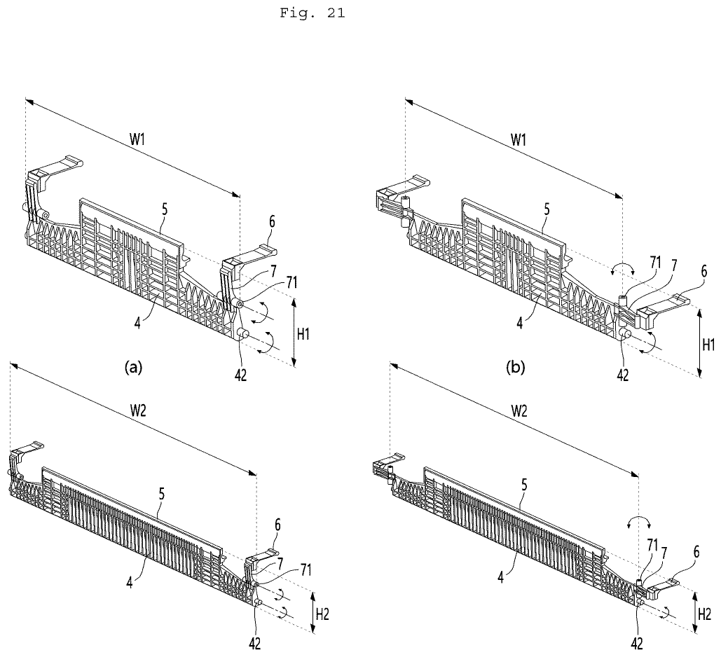

FIG. 21 illustrates another embodiment combining the first and second embodiments.

Refer to FIG. 21A. The handle 4, first axis 42, second axis 71, link 7, and pusher 6 shown in the first embodiment are proposed. It may have a narrow width w1 and a high height H1.

Refer to FIG. 21B. The present embodiment suggests the handle 4, the first axis 42, the second axis 71, the link 7, and the pusher 6. The second axis 71 may extend in the up-down direction (Z), as in the second embodiment. The open module 30 of the present embodiment may have a narrow width w1 and a high height H1. The open module 30 of the present embodiment may suggest an embodiment in which the position of the pusher 6 is shifted outwards.

Refer to FIG. 21c. This embodiment suggests the handle 4, the first axis 42, the second axis 71, the link 7, and the pusher 6. The handle 4 is similar to the handle 4 of the first embodiment, but may be provided longer in the left-right direction. The handle 4 is similar to the handle 4 of the first embodiment, but may be provided shorter in the up-down direction. The width and height of the handle 4 may be similar to those of the second embodiment and the handle 4. The open module 30 of this embodiment may have a wide width w2 and a low height H2.

Referring to FIG. 21D. This embodiment suggests the handle 4, the first axis 42, the second axis 71, the link 7, and the pusher 6. The handle 4 is similar to the handle 4 of the first embodiment, but may be provided longer in the left-right direction. The handle 4 is similar to the handle 4 of the first embodiment, but may be provided shorter in the up-down direction. The width and height of the handle 4 may be similar to those of the handle 4 of the second embodiment. The second axis 71 may extend in the up-down direction (Z) as in the second embodiment. The open module 30 of this embodiment may have a wide width w2 and a low height H2. The open module 30 of this embodiment may have an embodiment in which the pusher 6 is shifted to the outermost position.

Like the other embodiment, the handle 4 of the second embodiment may be provided in various shapes, similar to the handle 4 of the first embodiment.

### Third Embodiment

A refrigerator according to a third embodiment will be described below. The refrigerator according to the third embodiment may differ from the other embodiments in the relationship between the cap 8, the handle 4, the case 2, and the front panel 31.

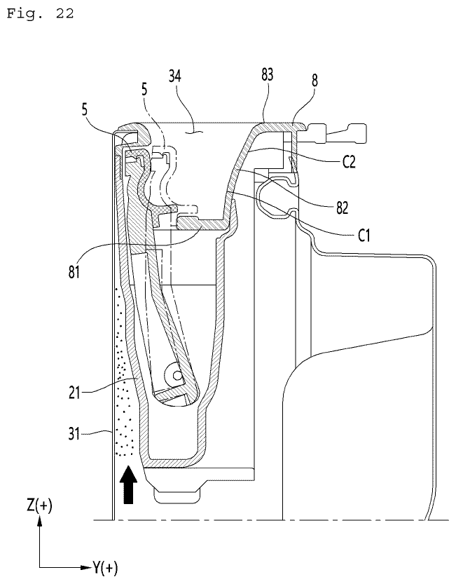

FIG. 22 is a cross-sectional view showing a cap recess according to the third embodiment. This drawing is a cross-sectional view of the handle of the refrigerator according to the third embodiment, viewed from the YZ plane. The virtual line of the handle in FIG. 22 shows the handle before it rotates.

Refer to FIG. 22. The cap recess 34 may include an opening through which the grip 5 is inserted. The opening may be provided in the entire area of the cap recess. The cap recess 34 may include both side walls defining both ends of the recess in the left-right direction (X). The cap recess may include a connecting portion connecting the both side walls. The connecting portion may have a lower wall 81 defining a lower portion of the recess. The lower wall may extend in the front-rear direction (Y). A rear wall 82 may be provided at the rear portion of the lower wall. The rear wall may extend in a rearward direction (+Y). The rear wall may extend upward (+Z). A gap for inserting a user's finger may be secured by the rear wall. Even if the width of the door in the front-rear direction (Y) is narrow, a gap for inserting a user's finger may be secured. The rear wall 82 may have at least one round shape. The rear wall may move more in a rearward direction (+Y) as it goes upward (+Z). Accordingly, the width of the cap recess for inserting a user's finger may be secured. For example, the width of the cap recess 34 may be secured to be 12 millimeters. The round shape of the rear wall may have at least two curvature radii. The curvature radius of a curvature radius portion c1 of the lower portion of the rear wall may be larger than the curvature radius of a curvature radius portion c2 of the upper portion of the rear wall. Through this, the insulation effect may be maximized. Through this, the insertion gap of the finger may be secured. The inner support plate 22 may be fastened to at least one of the rear wall and/or the lower wall of the cap recess. By placing the inner support plate on the rear wall and the lower wall of the cap recess, the exact positioning of the open module 30 and the gap may be accurately achieved.

The cap 8 may be fastened to the outer panel 31. The cap may cover the outer panel. The front upper end of the cap may cover the upper end of the outer panel. The front lower end of the cap may be in contact with the inner surface of the outer panel. The cap may be fastened to the case 2. The front lower end of the cap may be fastened to the outer support plate 21. The upper end of the outer support plate may be in contact with the inner surface of the outer panel. A foam member may be flowed into the upper end of the outer support plate up to the inner surface and the contact portion of the outer panel.

The outer surface of the case may be bent in response to the operation and shape of the handle 4 and the link 7. By the bending, the case may have a recess extending in the left-right direction (X). The recess may extend in a straight line. The outer support plate 21 may be provided to be curved by the recess. At least two recesses may be provided. The recess may be spaced apart from each other in the up-down direction. The outer support plate may be provided to be curved in the up-down direction. The outer support plate may be inclined rearward (+Y) as it goes downward. The gap between the outer panel 31 and the outer support plate 21 may be larger at the lower side than at the upper side. A foam member may be flowed in from the lower side upward through the gap between the outer panel 31 and the outer support plate 21. The foam member may be flowed in from the lower side of the open module 30. Since the gap between the outer panel 31 and the outer support plate 21 is wider at the lower side, the foam member may be flowed in more smoothly. This is because a foam member with a high pressure may be flowed in through the wider gap at the lower side.

A foam member may be flowed into the recess. The case may be firmly positioned by the foam member. The foam member may be hardened into a curved shape by the recess. Accordingly, the bonding strength between the foam member and the case may be enhanced. The gap between the outer support plate 21 and the inner support plate 22 may increase as it progresses upward. This facilitates the inflow of the foam member. Accordingly, it may be firmly positioned with respect to the open module 30 and the door. Accordingly, the handle 4 may rotate smoothly around the first axis 42. Accordingly, the link 7 may rotate smoothly around the second axis 71.

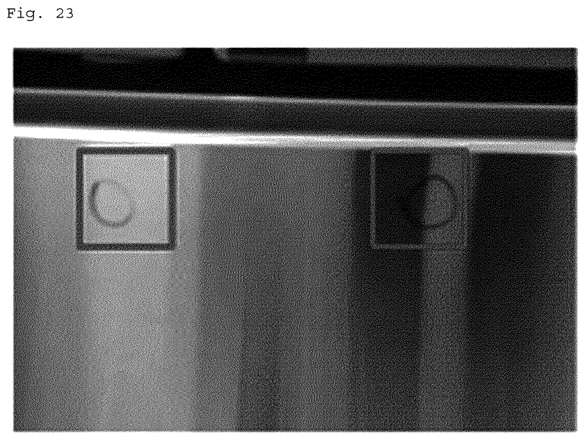

The foam member may be unevenly flowed into the gap between the outer panel 31 and the outer support plate 21. If the gap between the outer panel 31 and the outer support plate 21 is narrow, if the gap between the outer panel 31 and the outer support plate 21 is not wide at the lower side, or if the bonding between the outer panel 31 and the outer support plate 21 is poor, the foam member may be unevenly flowed in. In this case, an unfilled space, in which the foam member is not filled, may occur in the gap between the outer panel 31 and the outer support plate 21. This unfilled space may provide unevenness on the surface of the outer panel. This unevenness may cause long-term defects and deterioration in aesthetic appeal. FIG. 23 is a surface view of the outer panel including the unevenness. The unevenness may be removed by the open module 30 of the present embodiment.

### Fourth Embodiment

A refrigerator according to a fourth embodiment will be described below. The refrigerator according to the fourth embodiment may differ characteristically from other embodiments in its configuration for enhancing the insulation effect and preventing frost formation.

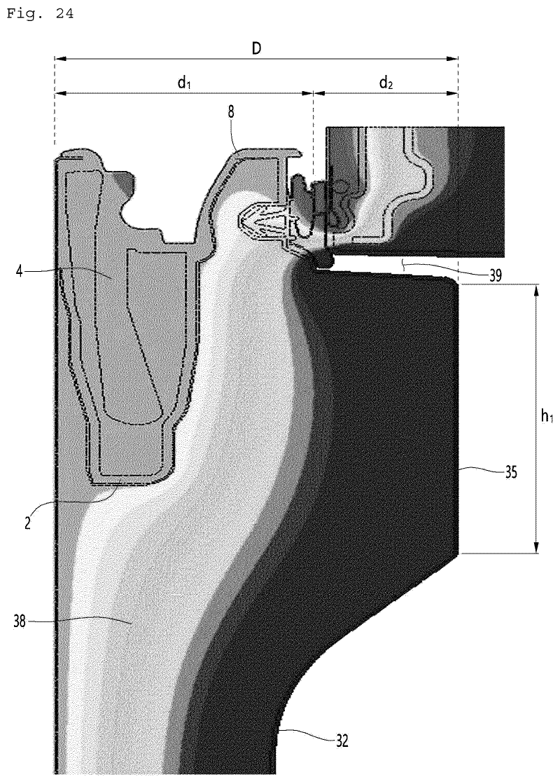

FIG. 24 is a drawing showing the insulation effect around the open module in the refrigerator according to the fourth embodiment. The lines in FIG. 24 represent isotherms. When the isotherms become denser, it may denote that the temperature change is severe. When the temperature change is severe, may denote that heat leakage is severe. Severe heat leakage may degrade insulation performance. Heat may move in the normal direction of the isotherm. FIG. 24 shows the results of a simulation performed using modeling.

FIG. 24 illustrates the case 2 to which the handle 4 is inserted, the outer panel 31, the inner panel 32, the cap 8, and the dike 35. An insulation gap 38 may be provided inside the door. The insulation gap may accommodate at least a portion of the open module 30. The insulation gap 38 may be filled with a foam member, for example, a polyurethane foam member, to enhance the insulation effect. In addition to the foam member, the insulation gap may also provide insulating members such as vacuum member and porous member. At least two of the above-mentioned insulating members may be provided together.

The internal area is not provided with an insulating member. The internal area may be considered an insulation-vulnerable area with weak insulation performance. This insulation-vulnerable area narrows the insulation gap 38 of the door, which may lead to a decrease in the door's insulation performance. The insulation performance of the internal area needs to be improved. This may secure the refrigerator's insulation performance. The pressing part may be provided in the same temperature range. The second, third, and fourth pressing parts may be provided in the same temperature range. All pressing parts may be provided in the same temperature range. Accordingly, the pressing part may not be affected by cold air. Accordingly, the temperature difference perceived by a user may be reduced. The isotherm of the internal area may be provided to be wider than the insulation gap. According to this configuration, the internal area's own heat transfer can be reduced.

The energy nose 39 may block internal airflow to enhance the insulation effect. It may be seen that the isotherm does not pass through the energy nose. The upper end of the dike 35 may create an energy nose. The dike may control the pattern of the isotherm. By controlling the shape of the isotherm, the insulation effect may be enhanced. The dike may have an upper surface that provides the energy nose 39. The dike may have an inner surface extending downward from the upper surface. The dike may have a lower surface that slopes forward from the lower end of the inner surface. The upper surface and the lower surface may have different inclination angles. The inclination angle of the lower surface may be greater than that of the upper surface. Here, the inclination angle may refer to the angle of inclination with respect to the front-rear direction (Y). The inner surface of the dike may have a certain length h1 in the up-down direction (Z). The dike may have a certain length in the front-rear direction (X) to provide an energy nose. The dike may have a length d2 in an up-down direction longer than the length d2 in a front-rear direction. The lower end of the inner surface of the dike may further extend downward from the lower end of the case 2. The dike may be provided in a trapezoidal shape.

The isotherm of the insulation gap may have a portion extending in a right-downward direction. Here, the right-downward direction may refer to a rearward direction (+Y) and a downward direction (−Z). A sufficient gap between isotherms may be maintained by the right-downward isotherm. By increasing the gap between isotherms, the insulation effect may be enhanced. Despite the thinness of the door, sufficient insulation performance may be achieved. The heat transfer may occur in a left-downward direction due to the isotherm. The dike may be provided at the upper end of the inner panel 32. Here, the left-downward direction may refer to a forward direction (−Y) and a downward direction (−Z). This heat transfer pattern may enhance insulation performance by increasing the heat transfer length.

The vertical plane (XZ plane) in the front-rear direction (Y) may be the actual extension direction of the wall along which the door provides insulation. The thickness of the door in the length of the front-rear direction (Y) may provide insulation. The energy nose 39 may provide insulation. The thickness of the door including the energy nose may be referred to as the main insulation area. The main insulation area may be referred to as an insulation gap. The main insulation area may include an insulation wall area (d1) and an energy nose area (d2). The insulation wall area may reduce heat conduction. The energy nose area may reduce convection heat through flow. The energy nose area may be equal to the length (d2) of the dike in the front-rear direction. The pusher 6 may be placed in the main insulation area. At least a portion of the pusher 6 may be placed in the energy nose area. At least a portion of the pressing part may be placed in the main insulation area. The entire pressing part may be placed in the main insulation area. This enhances insulation performance. The gasket may be placed in the main insulation area.

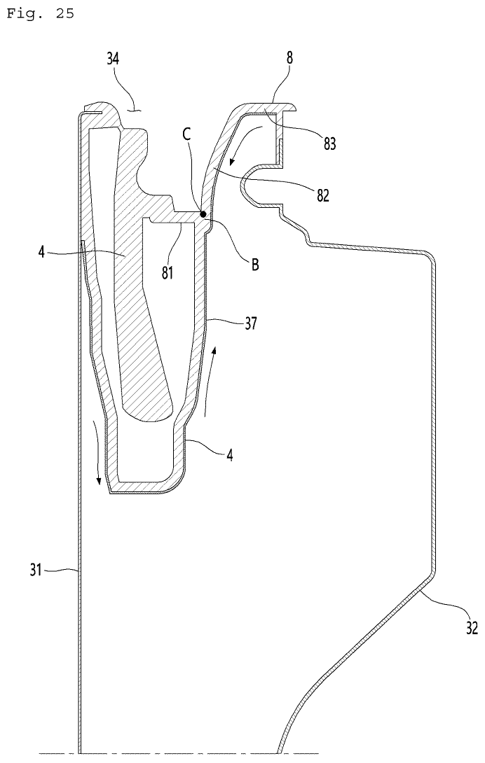

FIG. 25 is a drawing illustrating a configuration for preventing frost formation due to cold air on a refrigerator door according to a fourth embodiment.

Referring to FIG. 25, the point where frost formation occurs on the door may be a point with the lowest temperature on the outer surface of the door exposed to outside air. The lowest temperature point (C) may be at least one point. The lowest temperature point (C) may be adjacent to a place with which the cap 8 and the inner support plate 22 come into contact. In the open module 30, the lowest temperature point (C) may be a place with which the lower wall 81 and the rear wall 82 come into contact. In the open module 30, the lowest temperature point (C) may be a branching portion (B) where the flow of cold air branches. The branching may mean that the cold air flowing through the inner support plate 22 branches off to the lower wall 81 and the rear wall 82. A heat diffusion member 37 may be installed adjacent to the lowest temperature point (C). The heat diffusion member may be a heat diffusion plate. The heat diffusion plate may promote heat transfer. The heat diffusion member may use a metal plate. The heat diffusion plate may also diffuse cold air. By diffusing the cold air, the lowest temperature point may be prevented from dropping to a frost formation temperature. The heat diffusion plate may be provided on the rear surface of the rear wall 82 adjacent to the lowest temperature point (C). The heat diffusion plate may be provided on the lower surface of the lower wall 81 adjacent to the lowest temperature point (C). The heat diffusion plate may be provided on at least one of the rear surface and/or the front surface of the inner support plate 22 adjacent to the lowest temperature point (C).

If the door is thin, frost formation at the lowest temperature point may be severe. The heat diffusion plate may prevent frost formation. As an example, the drawing shows that the heat diffusion plate 37 is provided on the outer support plate 21, the lower support plate 23, the inner support plate 22, the rear wall 82, and the upper wall 83. Through this, external heat may be conducted to the lowest temperature point (C). The arrow illustrates the direction of heat transfer. The heat transfer path passing through the outer support plate 21, the lower support plate 23, and the inner support plate 22 may conduct heat from the outside air. The heat transfer path passing through the rear wall 82 and the upper wall 83 may conduct heat from the outside air. The heat transfer path passing through the rear wall 82 and the upper wall 83 may conduct heat from the heater. Here, a heater may be installed in the cabinet 11. The heater may prevent frost formation in the cabinet. The heater may also prevent frost formation on both the cabinet and the door. The heater may be installed in a partition wall that divides the storage space. Here, the partition wall may be a partition wall that separates the refrigerator compartment from the freezer compartment.

### Fifth Embodiment

A refrigerator according to a fifth embodiment will now be described. The fifth embodiment may differ characteristically from other embodiments in the left-right length of the cap recess and the pusher 6.

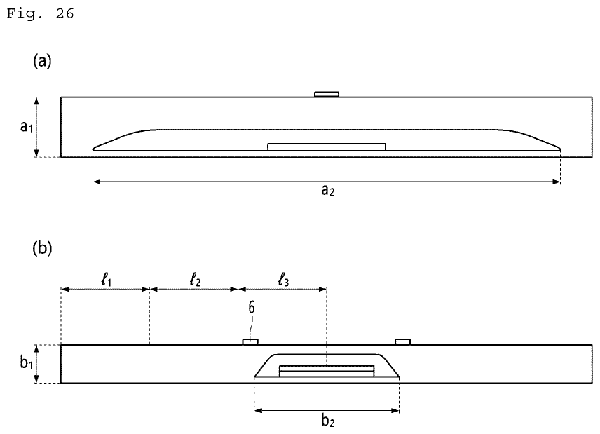

FIG. 26 is a drawing comparing the thicknesses of the door of the fifth embodiment with that of the comparative example. FIG. 26A shows a comparative example in which the cap recess is long horizontally and has a single pusher. FIG. 26B shows a fifth embodiment in which the cap recess is short horizontally and has at least two pushers.

Refer to FIG. 26. The length bl of the door end of the fifth embodiment in the front-rear direction (Y) is smaller than the length al of the door end of the comparative example in the front-rear direction (Y). Accordingly, the internal volume of the storage space can be increased. The issue of reduced insulation thickness at the door end may be solved by various methods as described. The length b2 of the cap recess of the embodiment in the left-right direction (X) may be larger than the length a2 of the cap recess of the comparative example in the left-right direction (X). Accordingly, the area where the insulation thickness is reduced can be shortened.

In the comparative example, there is a concern that the initial opening of the door may not be smooth due to a single pusher 6. The concentrated force at one location may not be sufficient for the initial opening of the door. Since the force applied to a single member is large, there is a problem that the size of each member increases. The embodiment may provide at least two pushers 6. The embodiment may provide two pushers 6a, 6b on the left and right sides. The pusher 6 may be provided symmetrically in the left-right direction (X). The pusher 6 may be placed adjacent to dividing points when the door is divided into three parts in the left-right direction (X). The pusher 6 may be placed in the middle area when the door is divided into three parts in the left-right direction (X). The pushers 6 may be placed adjacent to a second dividing point and a fourth dividing point from any one end, when the door is divided into six parts in the left-right direction (X). The drawing shows that it is adjacent to the second dividing point from the left. The pusher 6 may be placed in a third area and a fourth area from any one end when the door is divided into six parts in the left-right direction (X). According to the above configuration, the door may be initially opened with a minimum external force. Accordingly, the force applied to each member may be reduced. Accordingly, each member may be formed thin and long. Accordingly, the open module 30 may be provided in a smaller size.

The comparative example may be included within the scope of the present invention. The pusher 6 of the comparative example may be provided as a single pusher 6 located in the center of the door in the left-right direction. The single pusher 6 may be implemented by configuring the link 7 as a single unit, changing the position of the axis to the center, changing the position of the handle 4, and changing the vertical position of the pusher 6 to avoid interference.

### Sixth Embodiment

A refrigerator according to a sixth embodiment will be described below. The sixth embodiment may differ characteristically from other embodiments in the left-right length of the cap recess, the pusher 6, and the handle 4.

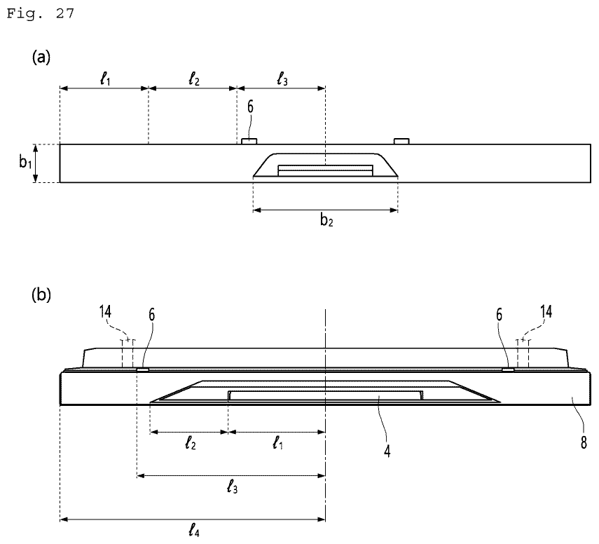

FIG. 27 is a drawing comparing the thicknesses of the door of the sixth embodiment with that of the comparative example. FIG. 27A is a comparative example where a cap recess is shorter in the left-right direction and has two pushers. FIG. 27B is a sixth embodiment where a cap recess is longer in the left-right direction and has at least two pushers. FIG. 27A may be an embodiment of the door suggested in the fifth embodiment. The sixth embodiment may have a cap recess that is shorter in the left-right direction than the comparative example of the fifth embodiment.

Refer to FIG. 27. The front-rear lengths of the door ends of the comparative example and the sixth embodiment may be the same. The length b2 of the cap recess in the left-right direction (X) of the sixth embodiment is shorter than the length a2 of the door of the comparative example in the front-rear direction (Y). Accordingly, the area where the insulation thickness is narrowed may be shortened. When the cap recess is provided to be longer in the left-right direction, accessibility of user may be improved. User may access not only the center of the door, but also any portion of the cap recess that is wide in one direction.

In the comparative example, there is a concern that the initial opening of the door may not be smooth even if two pushers 6 are used. This is because the position of the rail to which the door's static friction force is applied and the pusher 6 becomes more distant. In the embodiment, at least two pushers 6 may be provided at positions further outward in the left-right direction. In the embodiment, two pushers 6a, 6b may be provided on both left and right sides. The pushers 6 may be provided symmetrically in the left-right direction (X). The position of the pusher 6 may be positioned as far outward as possible with respect to the left-right direction (X) of the door. Accordingly, the pushers 6 may be adjacent to a pair of rail portions to which the static friction force is applied. The pushers 6 may be positioned outside the cap recess 34. This is because interference may occur when there exists a portion where the pusher 6 and the cap recess are aligned in the front-rear direction (Y). Among a pair of pushers 6, the right pusher 6 may be placed on the right of the cap recess 34. Among the pair of pushers 6, the left pusher 6 may be placed on the left of the cap recess 34. The pusher 6 may interfere with the hinge 14 in the up-down direction (Z). The hinge may rotate the first door 12, 13. The hinge may protrude in the up-down direction from the first door 12, 13. This is because interference may occur when there is a portion where the pusher 6 and the hinge are aligned in the up-down direction (Z). Among the pair of pushers 6, the right pusher 6 may be placed on the left of the hinge 14. Among the pair of pushers 6, the left pusher 6 may be placed on the right of the cap recess 34. In the pusher 6, the length 14 from the center of the door to the pusher 6 in the left-right direction may be longer than the length 13 from the pusher 6 to the distal end of the door in the left-right direction. Accordingly, the position of the pusher 6 can be as close as possible to the rail.

The handle 4 may be positioned at the center of the cap recess 34. The handle 4 may be provided to be long in the left-right direction (X). As the handle 4 becomes longer, a user may access the handle 4 conveniently. As the cap recess becomes longer, the handle 4 may be provided to be long. The length 11 from the center of the gap recess to the distal end of the handle 4 in the left-right direction may be longer than the length 12 from the distal end of the handle 4 to the distal end of the cap recess in the left-right direction.

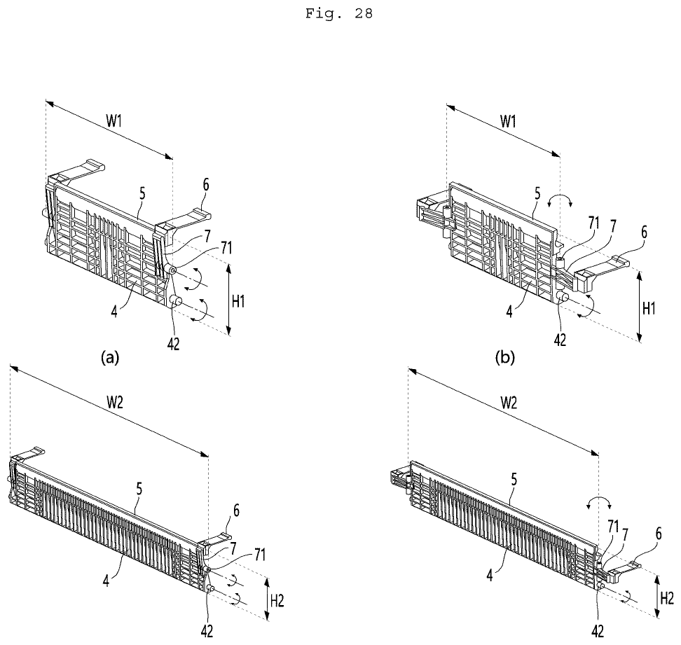

Accordingly, the configuration of the handle 4 may be characteristically provided differently to ensure that the handle 4 and the pusher 6 are adjacent to each other. FIG. 28 is a perspective view of a part related to a handle applicable to the sixth embodiment. The part of FIG. 28 may vary in the parts of the handle 4, the first axis 42, the second axis 71, the link 7, and the pusher 6 of FIG. 21.

Refer to FIG. 28. The configuration of the handle 4, the first axis 42, the second axis 71, the link 7, and the pusher 6 of the embodiment may be such that, compared to FIG. 21, the distal end of the handle 4 and the pusher 6 may be adjacent. The distal end of the handle 4 of the embodiment may be provided so that the handle 4 is longer in the left-right direction (X) compared to FIG. 21. The distal end of the link 7 of the embodiment may be provided so that the handle 4 is longer in the left-right direction (X) compared to FIG. 21. In the present embodiment, the second area 41 may be reduced in the left-right direction (X). The second area of the present embodiment may have a left-right direction area of the second pressing part 44. The second area may be deleted except for the left-right direction area of the second pressing part 44. According to the present embodiment, the effect of reducing the twisting force of the handle 4 may be obtained.

### Seventh Embodiment

A Refrigerator According to a Seventh embodiment will be described below. The seventh embodiment may differ characteristically from other embodiments in the relationship between the first axis 42 and the second axis 71.

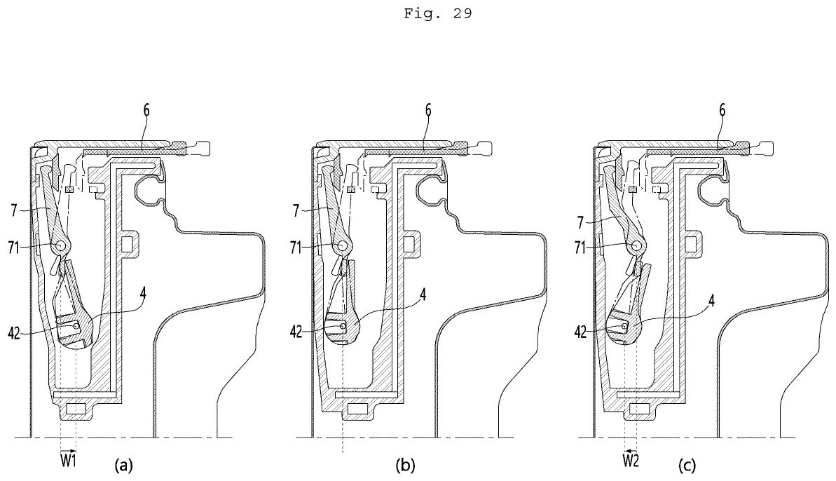

FIG. 29 is a side cross-sectional view of a door showing the positional relationship between the first axis 42 and the second axis 71 of a refrigerator according to the seventh embodiment and an eighth embodiment. FIG. 29A shows the positional relationship between the first axis 42 and the second axis 71 according to the first embodiment, and FIG. 29B shows the positional relationship between the first axis 42 and the second axis 71 according to the seventh embodiment.

Refer to FIG. 29. In the first embodiment, the second axis 71 may be positioned at front (−Y) compared to the first axis 42. The second axis 71 may be closer to a user than the first axis 42. Accordingly, a user may operate the grip with less force.

In the seventh embodiment, the second axis 71 and the first axis 42 may be positioned at the same position in the front-rear direction (Y). In the seventh embodiment, at least a portion of the second axis 71 and the first axis 42 may be aligned in the up-down direction (Z). In the seventh embodiment, the second axis 71 and the first axis 42 may overlap in the up-down direction (Z).

The configuration and operation of the seventh embodiment will be described in detail. The first axis 42 may be a central axis of rotation of the handle 4. The second axis 71 may be a central axis of rotation of the link 7. The first axis and the second axis may be spaced apart from each other in the up-down direction. Both the first and second axiss may extend in the horizontal direction (X). The point of action where force is transmitted to the link 7 may be placed above the first axis. Here, the point of action may be an initial contact point between the second pressing part 44 and the third pressing part 72. The point of action where the link transmits force may be adjacent to the upper end of the door. The point of action where the link transmits force may be on the upper end side of the door. The point of action where the link transmits force may be adjacent to the rear surface of the door. The point of action where the link transmits force may be on the rear surface side of the door. Here, the point of action of the link may be the fourth pressing part 73. The fourth pressing part 73 may be placed at the front (−Y) than the pressing action point of the handle. Here, the pressing action point of the handle may be the first pressing part 43. Conversely, the pressing action point of the handle may be placed at the rear (+Y) than the action point of the link. The first axis 42 may be the rotational center axis of the handle 4. The second axis 71 may be the rotational center axis of the link 7. The first axis 42 may be placed at the same position as the second axis 71 in the front-rear direction (Y). When an external force is applied, the handle 4 and the link 7 may rotate. Here, the external force may include a gripping force of a user. When an external force is applied, the handle 4 may rotate counterclockwise. When an external force is applied, the upper end of the handle 4 may rotate rearward (−Y). When an external force is applied, the link 7 may rotate clockwise. When an external force is applied, the upper end of the link 7 may rotate forward (+Y). When an external force is applied, the pusher 6 may move rearward (−Y). The shape of the link may change by the relative movement of the first and second axiss. For example, it may bend upward (Z). In the seventh embodiment, the upper end of the link may bend rearward. In addition to the link, the shape of at least one of the handle and/or the pusher may be changed. Accordingly, the open module can be installed in a narrow space.

According to the present embodiment, the outer panel 31 and the outer support plate 21 may be adjacent in the front-rear direction (Y). Heat from the outer panel may be transferred to the outer support plate. Accordingly, frost formation on the open module 30 can be prevented. In the present embodiment, the flowability of the foam member may deteriorate. To prevent this, a film that prevents unevenness may be attached to the outer surface of the outer panel.

### Eighth Embodiment

A refrigerator according to an eighth embodiment will be described below. The embodiment according to the eighth embodiment may differ characteristically from other embodiments in the relationship between the first axis 42 and the second axis 71.

FIG. 29A shows the positional relationship between the first axis 42 and the second axis 71 according to the first embodiment, and FIG. 29C shows the positional relationship between the first axis 42 and the second axis 71 according to the eighth embodiment.

Refer to FIG. 29A and FIG. 29C. In the first embodiment, the second axis 71 may be positioned at front (−Y) than the first axis 42. The second axis 71 may be closer to a user than the first axis 42. Accordingly, a user may operate the grip with less force.

In the eighth embodiment, the second axis 71 may be placed at the rear (+Y) in the front-rear direction (Y) than the first axis 42. In the eighth embodiment, at least a portion of the second axis 71 and the first axis 42 may not be aligned or overlapped in the up-down direction (Z).

The configuration and operation of the eighth embodiment will be described in detail. The first axis 42 may be the rotational center axis of the handle 4. The second axis 71 may be the rotational center axis of the link 7. The first axis and the second axis may be spaced apart from each other in the up-down direction. Both the first and second axiss may extend in the horizontal direction (X). The point of action where force is transmitted to the link 7 may be placed upward (+Z) than the first axis. Here, the point of action may be an initial contact point between the second pressing part 44 and the third pressing part 72. The first axis 42 may be placed at the rear (−Y) than the point of action. In the first embodiment, the first axis 42 may be placed at the front (+Y) than the point of action. Through this, the direction of force transmission and the magnitude of force can be controlled. The point of action where the link transmits force may be adjacent to the upper end of the door. The point of action where the link transmits force may be on the upper end side of the door. The point of action where the link transmits force may be adjacent to the rear surface of the door. The point of action where the link transmits force may be on the rear side of the door. Here, the point of action of the link may be the fourth pressing part 73. The fourth pressing part 73 may be placed at the rear (+Y) than the pressing action point of the handle. Here, the pressing action point of the handle may be the first pressing part 43. Conversely, the pressing action point of the handle may be placed at the front (−Y) than the point of action of the link. The first axis 42 may be the rotational center axis of the handle 4. The second axis 71 may be the rotational center axis of the link 7. The first axis 42 may be placed at the rear (−Y) in the front-rear direction (Y) than the second axis 71. When an external force is applied, the handle 4 and the link 7 may rotate. Here, the external force may include a gripping force of a user. When an external force is applied, the handle 4 may rotate counterclockwise. When an external force is applied, the upper end of the handle 4 may rotate rearward (−Y). When an external force is applied, the link 7 may rotate clockwise. When an external force is applied, the upper end of the link 7 may rotate forward (+Y). When an external force is applied, the pusher 6 may move rearward (−Y). The relative movement of the first and second axiss may change the shape of the link. For example, it may bend upward (Z). In addition to the link, the shape of at least one of the handle and/or the pusher may be changed. Accordingly, the open module can be installed in a narrow space. In the embodiment, the upper portion of the link is bent forward (+Y).

Heat at room temperature may be more smoothly transferred to the external support plate through the external panel. Accordingly, the frost formation function of the open module 30 can be performed smoothly. In the present embodiment, the flowability of the foam member may deteriorate. To prevent this, a film that prevents unevenness may be attached to the outer surface of the external panel.

### Ninth Embodiment

A refrigerator according to a ninth embodiment will be described below. The embodiment according to the ninth embodiment may have a relationship, between the first axis 42 and the second axis 71, which is characteristically different from other embodiments.

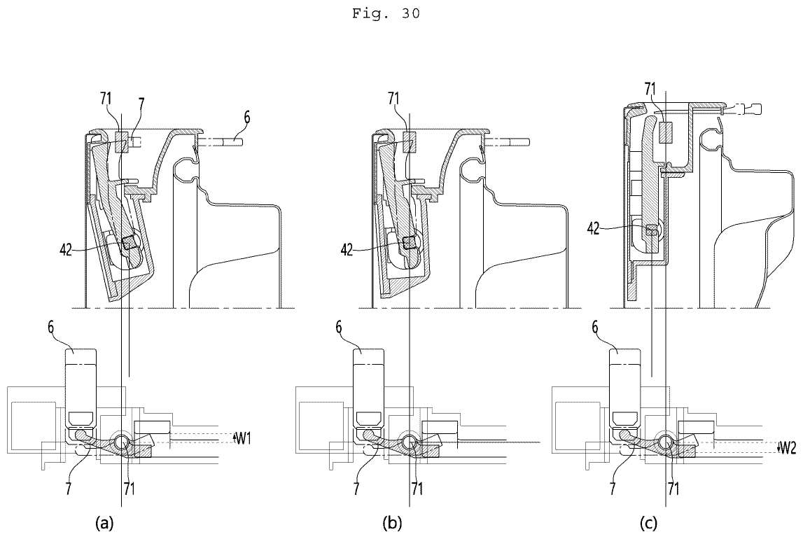

FIG. 30 is a side cross-sectional view of a door showing the positional relationship between the first axis 42 and the second axis 71 of a refrigerator according to the ninth embodiment and a tenth embodiment, FIG. 30A shows the positional relationship between the first axis 42 and the second axis 71 according to the second embodiment, and FIG. 30B shows the positional relationship between the first axis 42 and the second axis 71 according to the ninth embodiment.

Referring to FIG. 30, in the second embodiment, the second axis 71 may be positioned at the front (−Y) than the first axis 42. The second axis 71 may be closer to a user than the first axis 42. In the ninth embodiment, the second axis 71 and the first axis 42 may be positioned at the same position in the front-rear direction (Y). In the seventh embodiment, at least a portion of the second axis 71 and the first axis 42 may intersect in the up-down direction (Z).

The configuration and operation of the ninth embodiment will be described in detail. The first axis 42 may be the rotational center axis of the handle 4. The second axis 71 may be the rotational center axis of the link 7. The first axis and the second axis may be spaced apart from each other in the up-down direction. The first axis may extend in the horizontal direction (X). The second axis may extend in the up-down direction (Z). The point of action where force is transmitted to the link 7 may be placed above the first axis. Here, the point of action may be the initial contact point between the second pressing part 44 and the third pressing part 72. The point of action where the link transmits force may be adjacent to the upper end of the door. The point of action where the link transmits force may be on the upper end side of the door. The point of action where the link transmits force may be adjacent to the rear surface of the door. The point of action where the link transmits force may be on the rear surface side of the door. Here, the point of action of the link may be the fourth pressing part 73. The fourth pressing part 73 may be placed at the front (−Y) than the pressing action point of the handle. Here, the pressing action point of the handle may be the first pressing part 43. Conversely, the pressing action point of the handle may be placed at the rear (+Y) than the action point of the link. The first axis 42 may be the rotational center axis of the handle 4. The second axis 71 may be the rotational center axis of the link 7. The first axis 42 may be placed at the same position as the second axis 71 in the front-rear direction (Y). When an external force is applied, the handle 4 and the link 7 may rotate. Here, the external force may include the gripping force of the user. When an external force is applied, the handle 4 may rotate counterclockwise. Here, the counterclockwise direction may be based on the view in the left direction (−X). When an external force is applied, the upper end of the handle 4 may rotate rearward (−Y). When an external force is applied, the link 7 may rotate clockwise. Here, the clockwise direction may be based on the view in the downward direction (−Z). When an external force is applied, the outer end of the link 7 may rotate forward (+Y). Here, the outer end of the link may be the fourth pressing part 73. When an external force is applied, the pusher 6 may move rearward (−Y). The shape of the link may change depending on the relative movement of the first and second axiss. In addition to the link, the shape of at least one of the handle and/or the pusher may be changed. Accordingly, the open module may be mounted in a narrow space. For example, in the ninth embodiment, the degree of bending of the handle may be unfolded more than in the second embodiment.

In the ninth embodiment, the second axis 71 and the first axis 42 may overlap in the up-down direction (Z). According to the present embodiment, the outer panel 31 and the outer support plate 21 may be adjacent in the front-rear direction (Y). Heat of the outer panel may be transferred to the outer support plate. Accordingly, frost formation on the open module 30 may be prevented. In the present embodiment, the flowability of the foam member may deteriorate. To prevent this, a film that prevents unevenness may be attached to the outer surface of the outer panel.

### Tenth Embodiment

A refrigerator according to a tenth embodiment will be described below. The tenth embodiment may differ characteristically from other embodiments in the relationship between the first axis 42 and the second axis 71.

FIG. 30A a shows the positional relationship between the first axis 42 and the second axis 71 according to the second embodiment, and FIG. 30C shows the positional relationship between the first axis 42 and the second axis 71 according to the tenth embodiment.

Referring to FIG. 30. In the second embodiment, the second axis 71 may be positioned at the front (−Y) than the first axis 42. The second axis 71 may be positioned closer to a user than the first axis 42. In the tenth embodiment, the second axis 71 may be placed at the rear (+Y) in the front-rear direction (Y) than the first axis 42.

The configuration and operation of the tenth embodiment will be described in detail. The first axis 42 may be the rotational center axis of the handle 4. The second axis 71 may be the rotational center axis of the link 7. The first axis and the second axis may be spaced apart from each other in the up-down direction. The first axis may extend in the horizontal direction (X). The second axis may extend in the up-down direction (Z). The point of action where force is transmitted to the link 7 may be placed above the first axis. Here, the point of action may be the initial contact point between the second pressing part 44 and the third pressing part 72. The point of action where the link transmits force may be adjacent to the upper end of the door. The point of action where the link transmits force may be on the upper end side of the door. The point of action where the link transmits force may be adjacent to the rear surface of the door. The point of action where the link transmits force may be on the rear surface side of the door. Here, the point of action of the link may be the fourth pressing part 73. The fourth pressing part 73 may be placed at the rear (+Y) than the pressing action point of the handle. Here, the pressing action point of the handle may be the first pressing part 43. Conversely, the pressing action point of the handle may be placed at the front (−Y) than the action point of the link. The first axis 42 may be the rotational center axis of the handle 4. The second axis 71 may be the rotational center axis of the link 7. The first axis 42 may be placed at the rear (−Y) in the front-rear direction (Y) than the second axis 71. When an external force is applied, the handle 4 and the link 7 may rotate. Here, the external force may include a gripping force of a user. When an external force is applied, the handle 4 may rotate in a counterclockwise direction. Here, the counterclockwise direction may be based on the view in the left direction (−X). When an external force is applied, the upper end of the handle 4 may rotate rearward (−Y). When an external force is applied, the link 7 may rotate in a clockwise direction. Here, the clockwise direction may be based on the view in the downward direction (−Z). When an external force is applied, the outer end of the link 7 may rotate forward (+Y). Here, the outer end of the link may be the fourth pressing part 73. When an external force is applied, the pusher 6 may move rearward (−Y). The shape of the link may change depending on the relative movement of the first axis and the second axis. For example, it may bend in the upward direction (Z). In addition to the link, the shape of at least one of the handle and/or the pusher may be changed. Accordingly, the open module may be mounted in a narrow space. The present embodiment exemplifies that the handle is provided in a straight line.

In the tenth embodiment, at least a portion of the second axis 71 and the first axis 42 may not intersect or overlap in the up-down direction (Z). Heat at room temperature may be more smoothly transferred to the external support plate through the external panel. Accordingly, the frost-forming function of the open module 30 may be smoothly performed. In the present embodiment, the flowability of the foam member may deteriorate. To prevent this, a film that prevents unevenness may be attached to the outer surface of the external panel.

### Eleventh Embodiment

A refrigerator according an eleventh embodiment will now described below. The eleventh embodiment may differ characteristically from other embodiments in an operating method of a door in which the open module 30 operates.

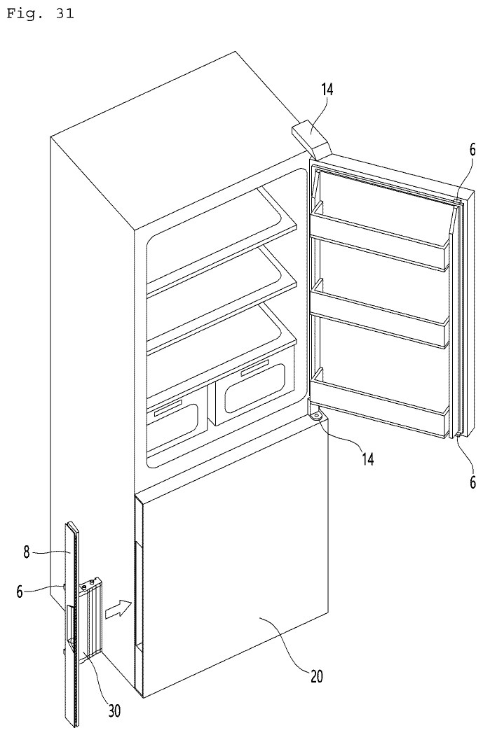

FIG. 31 is a perspective view of a refrigerator according to the eleventh embodiment. The refrigerator of the eleventh embodiment may include at least two doors that pivot on hinges. One of the doors 12 may be a refrigerator compartment door. The other of the doors 20 may be a freezer compartment door.

Refer to FIG. 31. The open module 30 may be provided on at least one of the doors 12 and 20. The open module 30 may be positioned on the opposite side to the hinge 14. For example, the hinge 14 may be provided on the right surface of the door 12, 20. In this case, the open module 30 may be provided on the left surface of the door. Obviously, it may also be positioned on the opposite or different side.

The cap 8 may be provided to extend in an up-down direction from a free end of the door. The cap recess may extend in an up-down direction. A user may access the cap recess by reaching up and down with their hand. In another embodiment, the cap recess may be accessed by aligning the fingers left and right. In the present embodiment, the cap recess may be accessed by aligning the fingers up and down. Accordingly, the open module 30 may be used more conveniently. At least two pushers 6 may be spaced apart from each other in an up-down direction. The pushers 6 may be spaced apart in an up-down direction like the hinge. The pusher 6 may press against the side edge of the cabinet.

### INDUSTRIAL APPLICABILITY

According to the present invention, the initial opening of the door may be made more convenient. According to the present invention, the handling of the refrigerator may be made more convenient. It may be applied to the doors of refrigerators which have recently become larger and heavier.

1. A refrigerator comprising:
a cabinet for providing a storage space;
a door for opening and closing the storage space;
a handle which rotates around a first axis by receiving an external force;
a pusher which receives the external force so as to move the door far away from the cabinet when the door is opened ;
a first pressing part which is configured to be provided on the handle so as to receive the external force, and formed in a first direction based on the first axis; and
a second pressing part which is configured to be provided on the handle so as to transmit the external force to the pusher, and formed in a first direction based on the first axis.

2. The refrigerator of claim 1, further comprising:
a link which is interposed between the handle and the pusher and rotates; and
a second axis supporting the rotation of the link.

3. The refrigerator of claim 2, wherein the second axis is placed in the first direction of the first axis.

4. The refrigerator of claim 3, wherein an extension direction of the first axis intersects with an extension direction of the second axis.

5. The refrigerator of claim 3, wherein an extension direction of the first axis is parallel to an extension direction of the second axis.

6. The refrigerator of claim 2, wherein a contact portion between the link and the handle is provided in a second direction based on the second axis.

7. The refrigerator of claim 6, wherein the first direction and the second direction are opposite directions.

8. The refrigerator of claim 1, further comprising:
a case having an open upper surface to accommodate at least a portion of the handle; and
a cover which is provided on both sides of the case and supports the first axis.

9. The refrigerator of claim 1, further comprising a support plate accommodating the handle,
wherein the support plate comprises:
an inner support plate supporting the first axis; and
an outer support plate fastened to the inner support plate.

10. The refrigerator of claim 9, further comprising a cover which is provided on at least one of both sides of the inner support plate, and supports at least one of the first axis and/or the second axis.

11. The refrigerator of claim 9, wherein the cover comprises:
a first surface which provides a first shafting that supports the first axis; and
a second surface which provides a second shafting that supports the second axis, and is different from the first surface.

12. The refrigerator of claim 1, satisfying at least one of:
a condition wherein the handle pushes the link in a forward direction (−Y);
a condition wherein the handle pushes a rear surface of the link in the forward direction;
a condition of including an elastic member that comes into contact with the pusher and pushes the pusher in the forward direction; and/or
a condition of including an elastic member that comes into contact with the pusher and pushes the pusher in the forward direction, wherein a center line of the elastic member is above a center line of a gasket.

13. The refrigerator of claim 1, satisfying at least one of:
a condition wherein at a contact portion between the handle and the link, a slip length of the link is smaller than a thickness of the link;
a condition wherein at the contact portion between the handle and the link, the slip length of the link is longer than a slip length of the handle;
a condition wherein the contact portion between the handle and the link passes through an extension line of the second axis when the handle moves;
a condition wherein a thickest portion among the link and the handle is provided on the handle;
a condition wherein a distance between the contact portion and the first axis is greater than a distance between the contact portion and the second axis;
a condition wherein the contact portion moves in the forward direction (−Y) when the handle and the link operate;
a condition wherein the link has a first area close to the second axis and a second area far from the second axis, the first area being thicker than the second area; and/or
a condition wherein a length of the handle is longer than a length of the link.

14. The refrigerator of claim 1, further comprising:
a condition of having a third pressing part adjacent to the handle on the link with respect to the second axis, and
a fourth pressing part adjacent to the pusher on the link with respect to the second axis,
satisfying at least one of:
a condition wherein a thickness/length of the link of the third pressing part is greater than that of the fourth pressing part, and/or
a condition wherein when a point where an external force is applied to the first pressing part is defined as a point of action (A), and a contact portion (C) of the handle and the link, a distance between the point of action and the contact portion is provided to be shorter than a distance between the point of action and the first axis.

15. The refrigerator of claim 1, satisfying at least one of:
a condition of having a first virtual axis in a front-rear direction (Y) with respect to the first axis, and a second virtual axis in an up-down direction (Z) with respect to the first axis, wherein the second axis is closer to the second virtual axis than the first virtual axis, or the second axis passes through the second virtual axis;
a condition of having a first virtual axis in a front-rear direction (Y) with respect to the first axis, and a second virtual axis in an up-down direction (Z) with respect to the first axis, wherein when the first virtual axis is an X-axis and the second virtual axis is a Y-axis to provide a quadrant, a contact point between the handle and the link is placed in at least one of a first quadrant and a second quadrant;
a condition of providing a shortest virtual line connecting the first axis and the second axis, wherein an angle formed by the virtual line with respect to a front-rear direction (Y) is greater than an angle formed by the virtual line with respect to an up/down direction (Z); and/or
a condition of providing a shortest virtual line connecting the first axis and the second axis, wherein a point where an external force is applied to the first pressing part is defined as a point of action, of providing a contact portion of the handle and the link, and of providing a second virtual line connecting the point of action and the contact portion, wherein a length of the first virtual line is longer than a length of the second virtual line.

16. The refrigerator of claim 1, further comprising at least one of a hinge for rotating the door and/or a rail for sliding the door.

17. A refrigerator comprising:
a cabinet for providing a storage space;
a door for opening and closing the storage space;
a handle which rotates around a first axis by receiving an external force;
a pusher which receives the external force so as to move the door far away from the cabinet when the door is opened; and
a second pressing part which is provided on the handle and configured to transmit the external force to the pusher, and is positioned in a first direction with respect to the first axis, when a direction facing a point where the external force is applied with respect to the first axis is defined as the first direction.

18. The refrigerator of claim 17, further comprising:
a link which is interposed between the handle and the pusher, and rotates; and
a second axis supporting the rotation of the link,
wherein the second axis is closer to the point where the external force is applied than the first axis.

19. The refrigerator of claim 18, further comprising a first virtual axis in a front-rear direction (Y) with respect to the first axis and a second virtual axis in an up-down direction (Z) with respect to the first axis,
wherein when the first virtual axis is defined as a X-axis and the second virtual axis is defined as a Y-axis to provide a quadrant, with respect to the quadrant, the second axis is closer to a front of the door (−Y) than the first axis, is far from the front of the door (+Y), or at least partially overlaps vertically.

20. A refrigerator comprising:
a cabinet for providing a storage space;
a door for opening and closing the storage space;
a handle which rotates around a first axis by receiving an external force; and
a pusher which receives the external force and moves the door far away in a forward direction (−Y) from the cabinet.
